(19) United States
(12) Patent Application Publication
(10) Pub. No.: US 2016/0376422 A1
(43) Pub. Date: Dec. 29, 2016

(54) NITRILE-BUTADIENE RUBBERS THAT ARE STABLE IN STORAGE AND METHOD FOR PRODUCING SAME

(71) Applicant: ARLANXEO DEUTSCHLAND GMBH, Dormagen (DE)

(72) Inventor: Werner Obrecht, Moers (DE)

(21) Appl. No.: 15/109,014

(22) PCT Filed: Dec. 29, 2014
(86) PCT No.: PCT/EP2014/079372

§ 371 Date: Jun. 29, 2016

(30) Foreign Application Priority Data
Dec. 30, 2013 (EP) 13199842.9

(51) Int. Cl. C08K 5/13; C08K 5/00

(52) U.S. Cl. CPC C08K 5/13; C08K 5/0025

(57) ABSTRACT

Novel phenol-containing nitrile rubbers having a specific phenol content are provided, as are a process for production thereof, vulcanizable mixtures based thereon and vulcanizes thus obtained. The vulcanizes feature particularly good storage stability, moduli and elongation at break.

The invention relates to novel phenol-containing nitrile rubbers, to a process for production thereof, to vulcanizable mixtures comprising the novel nitrile rubbers and to vulcanizates obtainable therefrom.

Nitrile rubbers, also abbreviated to “NPR”, are understood to mean rubbers which are co- or terpolymers of at least one α,β-unsaturated nitrile monomer, at least one conjugated diene monomer and optionally one or more further copolymerizable monomers.

Nitrile rubbers of this kind and processes for preparation thereof are known; see, for example W. Hofmann, Rubber Chem. Technol. 36 (1963) 1 and Ullmann's Encyclopedia of Industrial Chemistry, VCH Verlagsgesellschaft, Weinheim, 1993, p. 255-261.

Nitrile rubbers are used in a wide variety of different fields of use, for example for seals, hoses, drive belts and damping elements in the automotive sector, and also for stators, well seals and valve seals in the oil production sector, and also for numerous parts in the aviation industry, the electrical industry, in mechanical engineering and in shipbuilding. These applications require mixtures of the nitrile rubber with various mixture constituents, especially with sulphur and with vulcanization accelerators. To avoid premature onset of vulcanization in the course of mixture production, the rubber mixtures must have a long scorch time. At the same time, the storage stability of the nitrile rubber, the vulcanization rate of the rubber mixtures and the properties of the vulcanizates, especially the modulus level at 300% elongation, must not be impaired.

NBR is prepared by emulsion polymerization, which initially gives an NBR latex. The NBR solids are 2isolated from this latex by coagulation. For the coagulation, salts and acids are used. With regard to the coagulation of the latices with metal salts, it is known that much greater amounts of electrolyte are required for monovalent metal ions, for example in the form of sodium chloride, than for polyvalent metal ions, for example in the form of calcium chloride, magnesium chloride or aluminium sulphate (Kolloid-Z. 154, 154 (1957)). It is also known that the use of polyvalent metal ions leads to a greater or lesser incorporation of the emulsifier in the product (Houben-Weyl (1961), Methoden der Org. Chemie [Methods of Organic Chemistry], Makromolekulare Stoffe 1 [Macromolecular Substances 1], p. 484). According to Houben-Weyl (1961), Methoden der Org. Chemie, Makromolekulare Stoffe 1, p. 479, “not only is it necessary to very carefully wash out the electrolytes used again, but the finished product should also be free of the catalysts and emulsifiers from the batch. Even small residues of electrolytes result in turbid and cloudy pressed and injection-moulded parts, the spoil the electrical properties, and they increase the water absorption capacity of the finished product” (quotation). There is no pointer in Houben-Weyl as to how a latex has to be worked up in order to obtain nitrile rubbers which are storage-stable, vulcanize quickly and, after the vulcanization, have a high modulus level and low water swelling.

The level attained to date in the mechanical properties of vulcanizates of hydrogenated nitrile rubber, especially the level of modulus and compression set, is still unsatisfactory.

According to U.S. Pat. No. 2,281,613, aliphatic mercaptans having a carbon number >6, preferably 6-12, are used for molecular weight regulation in the emulsion polymerization of butadiene and butadiene derivatives, and for copolymerization of butadiene with other monomers such as acrylonitrile. The mercaptans are added in portions or continuously in the course of the polymerization. In this way, the formation of gel in the polymerization is avoided. U.S. Pat. No. 2,281613 does not mention the use of aging stabilizers. Therefore, it is not possible to infer any measures for the improvement of the modulus level and compression set for vulcanizates of nitrile rubber by means of an aging stabilizer and the amount thereof.

U.S. Pat. No. 2,434,536 discloses addition, in the course of the copolymerization of butadiene and acrylonitrile, which is conducted as an emulsion polymerization, of mercaptans having 8 to 16 carbon atoms in portions, or continuously, with metered addition of mercaptans having high molar mass at the start of the polymerization and of mercaptans having lower molar mass with increasing monomer conversion. In this way, “plasticity” and “masticizability”, and hence processability on a roller and a Banbury mixer, of rubbers which are obtained at high polymerization conversions are improved. U.S. Pat. No. 2,434,536 does not mention the use of aging stabilizers. It is not possible to infer any measures for improving the modulus level and compression set of vulcanizates of hydrogenated nitrile rubber via the aging stabilizer used in the preparation of the nitrile rubber feedstock and the amount thereof from U.S. Pat. No. 2,434536.

GB 888040 discloses a process for coagulating nitrile rubber and polychloroprene latices which are produced with oleate-based emulsifiers. For the purpose of coagulation, an aqueous solution of ammonium salt is added to the alkaline latex and then heated. As a result of the reduction in pH which takes place in the course of this, coagulation of the latex sets in. It is apparent from the examples section that 15 parts of 2,2′-dihydroxy-3,3′-dicyclohexyl-5,5′-dimethyldiphenylmethane are added to the nitrile rubber latex before the coagulation. On the basis of GB 888040 A, it is not possible to draw any further conclusions about the influence of aging stabilizers on the properties of nitrile rubber vulcanizates. More particularly, it is not possible to infer any measures for improving processing reliability, vulcanization rate and the modulus level without losses in storage stability.

DD 154 702 discloses a process for free-radical copolymerization of butadiene and acrylonitrile in emulsions, which is controlled via a specific metering programme for the monomers and the molecular weight regulator, for example tert-dodecyl mercaptan, and in which the latices obtained are worked up by coagulation in an acidic medium to give the solid rubber. A significant advantage of the process is stated to be that the resin soaps and/or fatty acid soaps used as emulsifier remain within the rubber through the use of acids in the coagulation, and thus are not washed out as in other processes. This is claimed not just to have the advantage of good properties of the NBR but particularly also to improve the economics of the process and to avoid wastewater pollution by washed-out emulsifier. For the butadiene-acrylonitrile copolymers obtained with 10-30% by weigh of acrylonitrile, it is stated that they feature good elasticity and low-temperature properties combined with elevated swell resistance and advantageous processibility. DD 154 702 does not give any information as to the use of aging stabilizers. Accordingly, it is not possible to infer any clues as to the influence of aging stabilizers on storage stability, processing reliabilty and vulcanization rate of the rubber mixtures, or as to the influence of aging stabilizers on the properties of the unvulcanized nitrile rubbers from DD 154 702.

DE-A 23 32 096 discloses that rubbers can be precipitated from their aqueous dispersions with the aid of methyl cellulose and a water-soluble alkali metal, alkaline earth metal, aluminium or zinc salt. It is described as an advantage of this process that a coagulate almost completely free of extraneous constituents, such as emulsifiers, catalyst residues and the like, is obtained, since these extraneous substances are removed together with the water on removal of the coagulate and any remaining residues are washed out completely with further water. DE-A 24 25 441 uses, in the electrolyte coagulation of rubber latices, as an assistant instead of methyl cellulose, 0.1-10% by weight (based on the rubber) of water-soluble C₂-C₄ alkyl celluloses or hydroxyalkyl celluloses in combination with 0.02 to 10% by weight (based on the rubber) of a water-soluble alkali metal, alkaline earth metal, aluminium or zinc salt. Here too, the preferred water-soluble salt used is sodium chloride. The coagulate is removed mechanically and optionally washed with water, and the rest of the water is removed. Here too, it is stated that the extraneous substances, as in DE-A 23 32 096, are in fact completely removed together with the water in the removal of the coagulate and any residues still remaining are washed out completely by the washing with further water. No information is given as to the residual amounts of the impurities in these nitrile rubbers. Moreover, neither DE-A 23 32 096 nor DE-A 24 25 441 contains any information as to the type and amount of aging stabilizers which are added to the nitrile rubber before workup. Therefore, it is not possible to conclude any teachings as to the dependence of properties of the nitrile rubber on the type and amount of aging stabilizer.

DE-A 27 51 786 states that the precipitation and isolation of rubbers from aqueous dispersions thereof can be performed with a smaller amount of (hydroxy)alkyl cellulose when 0.02 to 0.25% by weight of a water-soluble calcium salt is used. It is again described as an advantage that this process affords an extremely pure coagulate which is in fact completely free of extraneous constituents, such as emulsifiers, catalyst residues and the like. These extraneous substances are removed together with the water in the course of removal of the coagulate, and any residues still remaining can be washed out with water. It is further stated that the properties of the isolated rubbers are not adversely affected by coagulation with a calcium salt. It is said that, instead, a rubber in which the vulcanizate properties are not impaired and are entirely satisfactory is obtained. This is described as surprising because impairment of the rubber properties was frequently observed when polymers were precipitated from dispersions with the aid of polyvalent metal ions such as calcium or aluminium ions. The rubbers of DE-A 27 51 786 had no retardation or deterioration whatsoever, for example on scorch and/or full vulcanization. There is not information as to the type and amount of aging stabilizers that are added to the nitrile rubber latex before the workup, nor as to the influence of these aging stabilizers on the properties of nitrile rubber produced therefrom and vulcanizates thereof.

As in the above-described patents, it is also the aim of DE-A 30 43 688 to reduce the amounts of electrolyte needed for latex coagulation to a minimum level. For this purpose, in the electrolyte coagulation of latices, as well as the inorganic coagulant, either plant-based protein-containing materials or polysaccharides, for example starch and water-soluble or -insoluble polyamine compounds, are used as an assistant. Preferred inorganic coagulants described are alkali metal or alkaline earth metal salts. By means of the specific additives, it is possible to reduce the amounts of salt needed for a quantitative latex coagulation. There is no information as to the type and amount of aging stabilizers that are added to the nitrile rubber latex before the workup, nor as to the influence of these aging stabilizers on the properties of nitrile rubber and vulcanizates thereof.

According to U.S. Pat. No. 2,487,263, the latex coagulation of styrene/butadiene rubbers is conducted not with use of metal salts but with the aid of a combination of sulphuric acid with gelatin (“glue”). The amount and concentration of the sulphuric acid should be chosen such that the pH of the aqueous medium is set to a value <6. The latex coagulation forms discrete, non-coherent rubber crumbs having good filterability and washability. The styrene/butadiene rubber thus obtained has a lower water absorption capacity, a lower ash content and a higher electrical resistance than rubbers which are coagulated with the aid of salts without addition of gelatin. There is no disclosure as to what effects, if any, the coagulation with sulphuric acid with addition of gelatin has on storage stability, vulcanization rate and vulcanizates properties, and more particularly on the modulus level of rubbers. Use of aging stabilizers is likewise not addressed.

U.S. Pat. No. 4,383,108 describes the use of a nitrile rubber by emulsion polymerization using sodium laurylsulphate as emulsifier. The latex obtained here is coagulated by means of an aqueous solution o f magnesium sulphate and aluminium sulphate in a molar magnesium/aluminium ratio of 0.3/1 to 2/1. In this case, the nitrile rubber is obtained in the form of a powder having particle diameters in the range of 0.3 to 4 mm, which is optionally admixed with zinc soaps as antiagglomerants prior to drying. It can be inferred from the examples section of U.S. Pat. No. 4,383,108 that the latex is stabilized prior to the coagulation by addition of 1.5 parts by weight of a “phosphite of polyalkylphenol”. There is no information about the influence of aging stabilizer on properties of nitrile rubber, such as storage stability, processing reliability, vulcanization rate and modulus level at 300% elongation.

U.S. Pat. No. 5,708,132 describes the production of storage-stable and rapidly vulcanizing nitrile rubbers, wherein the nitrile rubber latex is admixed prior to coagulation with a mixture of a hydrolysis-susceptible and a hydrolysis-resistant aging stabilizer. Hydrolysis-susceptible aging stabilizers used as alkylated aryl phosphites, especially tris(nonylphenyl) phosphite. Hydrolysis-resistant aging stabilizers used are sterically hindered phenols, especially octadecyl 3,5di-t-butyl-4-hydroxyhydrocinnamate (Ultranox® 276). The combination of the two aging stabilizers reduces the hydrolysis rate of the phosphite-based aging stabilizer. It can be inferred from the general description of U.S. Pat. No. 5,708,132 that the sum total of the aging stabilizers is 0.25 to 3 parts by weight based on 100 parts by weight of rubber. It is shown that the pH of the crumb dispersion after the coagulation has a great influence on the storage stability of the nitrile rubber and on the vulcanization rate of a nitrile rubber mixture. U.S. Pat. No. 5,708,132 does not state what contents of aging stabilizers remain in the nitrile rubber after drying and what contents of aging stabilizer should be set in order that nitrile rubbers having good storage stability are obtained, and that rubber mixtures containing them have a rapid vulcanization rate and, in the vulcanized state, high modulus values at 300% elongation coupled with high scorch resistance.

U.S. Pat. No. 4,920,176 discloses that coagulation of a nitrile rubber latex according to the prior art using inorganic salts such as NaCl or CaCl₂ causes very high sodium, potassium and calcium contents and also distinct amounts of emulsifier to remain in the nitrile rubber. For the purpose of obtaining a nitrile rubber of maximum purity, according to U.S. Pat. No. 4,920,176, water-soluble cationic polymers are used in place of the inorganic salts in the coagulation of the nitrile rubber latex. These are, for example, those based on epichlorohydrin and dimethylamine. The vulcanizates obtained therefrom have lower swelling on contact with water and higher electrical resistance. These improvements in properties are attributed purely qualitatively to the minimal cation contents remaining in the product. U.S. Pat. No. 4,920,176 explicitly mentions aging stabilizers such as phenolic stabilizers and 2,6-di-tert-butyl-p-cresol. The aging stabilizers are added to the latex prior to latex coagulation, although no specific amounts are given. It is not possible to infer any instruction as to the preparation of a nitrile rubber which has high processing reliability of the rubber mixtures with rapid vulcanization rate and high level of the modulus at 300% elongation coupled with good storage stability from the teaching of U.S. Pat. No. 4,920,176.

The aim of EP-A-1 369436 was to provide nitrile rubbers of high purity. The emulsion polymerization is conducted in the presence of fatty acid salts and/or resin acid salts as emulsifiers, and then the latex coagulation is undertaken by addition of mineral or organic acids at pH values less than or equal to 6, option all with addition of precipitants. As additional precipitants, it is possible to use alkali metal salts of inorganic acids. It is also possible to add precipitation aids such as gelatin, polyvinyl alcohol, cellulose, carboxylated cellulose and cationic and anionic polyelectrolytes, or mixtures thereof. Subsequently, the fatty acids and resin acids formed are washed out with aqueous alkali metal hydroxide solutions and the polymer is subjected to shear until a residual moisture content of less than or equal to 20% is established. Nitrile rubbers having low residual emulsifier contents and cation contents are obtained. There is a lack of pointers for controlled production of nitrile rubbers having particular technological properties. The influence of aging stabilizers on the product properties such as storage stability, processing reliability and vulcanization rate of the rubber mixtures is not examined.

U.S. Pat. No. 4,965,323, the compression set of HNBR-based vulcanizates which are obtained by peroxidic vulcanization or by sulphur vulcanization is improved by contacting the nitrile rubber after the polymerization or after the hydrogenation with an aqueous alkali solution or the aqueous solution of an amine. In example 1, rubber crumbs that are obtained after removal of the solvent are washed in a separate process step with aqueous sodium carbonate solutions of different concentration. The pH of an aqueous THF solution obtained by dissolving 3 g of the rubber in 100 ml of THF and adding 1 ml of water while stirring is used as a measure of the alkali content. The pH is determined by means of a glass electrode at 20° C. For the production of vulcanizates of the hydrogenated nitrile rubber having low compression set, the pH of aqueous THF solution should be >5, preferably >5.5, more preferably >6. U.S. Pat. No. 4,965,323 does not contain any pointers as to the type and amount of aging stabilizer that should be used in the production of the nitrile rubber.

EP-A-0 692 496, EP-A-0 779 301 and EP-A-0 779 300 each describe nitrile rubbers based on an unsaturated nitrile and a conjugated diene, having 10-60% by weigh of unsaturated nitrile and a Mooney viscosity (ML1+4 @100° C.) in the range of 15-150 or, according to EP-A-0 692 496, of 15-65 Mooney units, and all of them having at least 0.03 mol of a C₁₂-C₁₆-alkylthio group per 100 mol of monomer units, said alkylthio group including at least three tertiary carbon atoms and a sulphur atom bonded directly to at least one of the tertiary carbon atoms. Each of the nitrile rubbers is prepared in the presence of a C₁₂-C₁₆-alkyl thiol of appropriate structure as molecular weight regulator, which functions as a “chain transfer agent” and is thus incorporated into the polymer chains as an end group.

With regard to latex coagulation, it is stated in each case that any desired coagulants can be used. Inorganic coagulants mentioned and used are calcium chloride and aluminium chloride. According to EP-A-0 779 301 and EP-A-0 779 300, a preferred embodiment consists in a nitrile rubber which is essentially halogen-free and is obtained by conducting the latex coagulation in the presence of a nonionic surface-active assistant and using halogen-free metal salts such as aluminium sulphate, magnesium sulphate and sodium sulphate. Coagulation using aluminium sulphate or magnesium sulphate is specified as preferable for obtaining the essentially halogen-free nitrile rubber. The nitrile rubber produced in this way in the examples has a halogen content of not more than 3 ppm. For the production of the nitrile rubbers, it is essential that the molecular weight regulators used are alkyl thiols in the form of the compounds 2,2,4,6,6-pentamethylheptane-4-thiol and 2,2,4,6,6,8,8-heptamethylnonane-4-thiol. It is pointed out that, when conventional tert-dodecyl mercaptan is used as chain transfer agent, nitrile rubbers having poorer properties are obtained.

For nitrile rubbers produced in this way, it is asserted that they have an advantageous profile of properties, and enable good processability of the rubber mixtures and low mould soiling in the course of processing. The vulcanizates obtained are said to have a good combination of low-temperature stability and oil resistance and posses good mechanical properties. It is additionally asserted that the nitrile rubbers have a short scorch time, a high crosslinking density is attainable and the vulcanization rate is high, especially in the case of NBR types for processing by injection moulding.

Nothing is said with regard to the use of aging stabilizers in the descriptions of EP-A-0 692 496, EP-A-0 779 301 and EP-A-0 779 300. It is apparent from the examples that an alkylated phenol not defined any further in terms of chemical structure is used as an aging stabilizer. It can also be inferred from the examples that 2 parts of the alkylated phenol are used. It is suspected that this means parts by weight. The reference parameter remains unclear (based on monomer or polymer). No further conclusions can be drawn as to the influence of the alkylated phenol which remains in the dry nitrile rubber on the properties of nitrile rubber and of hydrogenated nitrile rubber, and of the rubber mixtures and vulcanizates thereof, from EP-A-0 692 496, EP-A-0 779 301 and EP-A-0 779 300.

DE 102007024011 A describes a rapidly vulcanizing nitrile rubber having good mechanical properties, especially a high modulus 300 level, which possesses an ion index (“II”) of the general formula (I) in the range of 7-26 ppm×mol/g.

$$Ion index = \frac{3 c ( {Ca}^{2 +} )}{40 g \text{/} mol} - [ \frac{c ( {Na}^{+} )}{23 g \text{/} mol} + \frac{c ( {K}^{+} )}{39 g \text{/} mol} ] \qquad ( I )$$

where c(Ca²⁺), c(Na⁺) and c(K⁺) indicate the concentration of the calcium, sodium and potassium ions in the nitrile rubber in ppm. In order to obtain such a rapidly vulcanizing nitrile rubber, the coagulation is conducted in the presence of a salt of a monovalent metal and optionally of not more than 5% by weight of a salt of a divalent metal, and the temperature in the course of coagulation and subsequent washing is at least 50° C. In the general part of DE 102007024011, some aging stabilizers that are added to the nitrile rubber latex prior to coagulation are enumerated, although no amounts are stated. It is apparent from the examples section that the studies have been conducted with a constant amount of di-tert-butyl-p-cresol (1.25% by weight based on rubber solids). No further conclusions can be drawn about the influence of the 2,5-di-tert-butyl-p-cresol remaining in the dry nitrile rubber on the properties of nitrile rubber and of the rubber mixtures and vulcanizates thereof from DE 102007024011 A.

DE 102007024008 A describes a particularly storage-stable nitrile rubber containing specific isomeric C₁₆ thiol groups and having a calcium ion content of at least 150 ppm and a chlorine content of at least 40 ppm, based in each case on the nitrile rubber. The calcium ion contents of the nitrile rubbers produced in the inventive examples are 171-1930 ppm; the magnesium contents are 2-265 ppm. The calcium ion contents of the noninventive comparative examples are 2-25 ppm; the magnesium ion contents are 225-350 ppm. A storage-stable nitrile rubber of this kind is obtained when the latex coagulation is conducted in the presence of at least one salt based on aluminium, calcium, magnesium, potassium, sodium or lithium, coagulation or washing conducted in the presence of a calcium salt or washing water containing calcium ions and in the presence of a chlorine-containing salt. The chlorine contents of the inventive examples are in the range of 49 to 970 ppm, and those of the noninventive comparative examples in the range of 25 to 39 ppm. However, the relatively low chlorine contents at 25 to 30 ppm are obtained only when coagulation is effected with chloride-free precipitants such as magnesium sulphate, aluminium sulphate or potassium aluminium sulphate and is followed by washing with deionized water. In the general part of DE 102007024008, a number of aging stabilizers that are added to the nitrile rubber latex prior to coagulation are enumerated, although no amounts are stated in the general part. It is apparent from the examples of DE 102007024008 that the NBR latices used in the studies were each stabilized with 1.25% aby weight of 2,6-di-tert-butyl-p-cresol based on rubber solids; the amount of 2,6-di-tert-butyl-p-cresol used were not varied in the studies. Therefore, it is no t possible to draw any further conclusions as to the influence of the 2,5-di-tert-butyl-p-cresol remaining in the dry nitrile rubber on the properties of nitrile rubber and the rubber mixtures and vulcanizates thereof from DE 10200724008.

DE 102007024010 describes a further, rapidly vulcanizing nitrile rubber having an ion index (“II”) of the general formula (I) in the range of 0-60, preferably 10-25, ppm×mol/g

$$II = 3 [ \frac{c ( {Ca}^{2 +} )}{40 g \text{/} mol} + \frac{c ( {Mg}^{2 +} )}{24 g \text{/} mol} ] - [ \frac{c ( {Na}^{+} )}{23 g \text{/} mol} + \frac{c ( {K}^{+} )}{39 g \text{/} mol} ] \qquad ( I )$$

where c(Ca²⁺) c(Mg²⁺), c(Na⁺) and c(K⁺) indicates the concentration of the calcium, magnesium, sodium and potassium ions in the nitrile rubber in ppm, and the magnesium ion content is 50-250 ppm based on the nitrile rubber. In the examples for the nitrile rubbers produced in accordance with the invention, the calcium ion content c(Ca²⁺) is in the range of 163-575 ppm, and the magnesium ion content c(Mg²⁺) in the range of 57-64 ppm. In the examples for noninventive nitrile rubbers, the calcium ion content c(Ca²⁺) is in the range of 345-1290 ppm, and the magnesium ion content c(Mg²⁺) in the range of 2-440 ppm. Nitrile rubbers of this kind are obtained when the latex coagulation is conducted while observing particular measures, and the latex is adjusted to a temperature of less than 45° C. with a magnesium salt prior to coagulation. In the general part of DE 102007024010, a number of aging stabilizers that are added to the nitrile rubber latex prior to coagulation are enumerated, although no amounts are stated in the general part. It is apparent from the examples section that the studies have been conducted with a constant amount of di-tert-butyl-p-cresol (1.25% by weight based on rubber solids). No further conclusions can be drawn about the influence of the 2,5-di-tert-butyl-p-cresol remaining in the dry nitrile rubber on the properties of nitrile rubber and of the rubber mixtures and vulcanizates thereof from DE 102007024010.

EP 2 238 177 describes the production of nitrile rubber having high storage stability, by conducting the latex coagulation with alkaline earth metal salts in combination with gelatin. The nitrile rubbers have an exceptional index with regard to the contents of sodium, potassium, magnesium and calcium ions present in the nitrile rubber (ion index). In the general part of EP 2 238 177, a number of aging stabilizers that are added to the nitrile rubber latex prior to coagulation are enumerated, although no amounts are stated in the general part. It is apparent from the examples section that the studies were conducted with 2,2-methylenebis(4-methyl-6-tert-butyiphenol), the amount of which varied within a range from 0.1 to 0.8% by weight based on rubber solids. EP 2 238 177 shows that the storage stability of the nitrile rubber does not depend on the amount of 2,2-methylenebis(4-methyl-6-tert-butylphenol) and that, even when the smallest amount (0.1% by weight) of 2,2-methylenebis(4-methyl-6-tert-butylphenol) is used, adequate storage stabilities are achieved. On the basis of the data disclosed in EP 2 238 177, it is possible to draw the conclusion that the amount of 2,2-methylenebis(4-methyl-6-tert-butylphenol) has only a minor influence (if any) on the properties of nitrile rubber and the rubber mixtures and vulcanizates thereof.

EP 2 238 175 A describes nitrile rubbers having high storage stability, which are obtained by latex coagulation with alkali metal salts in combination with gelatin, and by means of specific conditions in the latex coagulation and the subsequent crumb washing. The nitrile rubbers have exceptional indices with regard to the amounts of sodium, potassium, magnesium and calcium ions remaining in the nitrile rubber (ion indices). In the general part, a number of aging stabilizers that are added to the nitrile rubber latex prior to coagulation are enumerated, although no amounts are stated in detail. It is apparent from the examples section that the studies have been conducted with a constant amount of 2,6-di-tert-butyl-p-cresol (1.0% by weight based on rubber solids). No further conclusions can be drawn about the influence of the 2,5-di-tert-butyl-p-cresol remaining in the dry nitrile rubber on the properties of nitrile rubber and of the rubber mixtures and vulcanizates thereof from EP 2 238 175 A.

EP 2 238 176 A describes nitrile rubbers having high storage stability, which are obtained by latex coagulation with alkaline earth metal salts in combination with polyvinyl alcohol. The nitrile rubbers have exceptional contents with regard to the contents of sodium, potassium, magnesium and calcium ions remaining in the nitrile rubber (ion index). In the general part of EP 2 238 176 A, a number of aging stabilizers that are added to the nitrile rubber latex prior to coagulation are enumerated, although no amounts are stated in detailed. It is apparent from the examples section that the studies have been conducted with a constant amount of 2,6-di-tert-butyl-p-cresol (1.0% by weight based on rubber solids). No further conclusions can be drawn about the influence of the 2,6-di-tert-butyl-p-cresol remaining in the dry nitrile rubber on the properties of nitrile rubber and of the rubber mixtures and vulcanizates thereof.

EP 1 331 074 A describes the production of mixtures based on nitrile-containing rubbers having a reduced tendency to mould soiling in an injection moulding process. The problem is solved by nitrile rubber or hydrogenated nitrile rubber having a fatty acid content in the range of 0.1-0.5% by weight. The influence of various mixture constituents on the mould soiling characteristics is studied, including that of di-tert-butyl-p-cresol, which is varied in amounts of 0.1-0.5 parts by weight. EP 1331074 A contains neither any figures for the contents of 2,5-di-tert-butyl-n-cresol present or remaining in the nitrile rubber or in the hydrogenated nitrile rubber nor any information as to the influence thereof on the properties of nitrile rubber, nitrile rubber mixtures and nitrile rubber vulcanizates.

In summary, it can be stated that, in spite of extensive literature relating to nitrile rubber, nothing has been disclosed to date as to the influence of the type and amount of the aging stabilizer remaining in the nitrite rubber after drying. More particularly, there is no information about a nitrile rubber containing an aging stabilizer in such an amount that the nitrile rubber is firstly storage-stable, and that the rubber mixtures thereof, coupled with high processing reliability, secondly have a simultaneously high vulcanization rate, and that the vulcanizates have very good mechanical properties.

The problem addressed by the present invention was thus that of providing a storage-stable nitrile rubber, the rubber mixtures of which simultaneously have a high processing reliability and a high vulcanization rate, and which, in the vulcanized state, additionally has an improved level of the stress value at 300% elongation and a very good elongation at break.

It has been found that, surprisingly, a nitrile rubber having the abovementioned profile of properties is obtained when it contains a specific substituted phenol in a particular amount. This novel nitrile rubber having the desired profile of properties becomes obtainable by providing the nitrile rubber, after the preparation thereof by emulsion polymerization and before the workup thereof, with the appropriate specific substituted phenol in a particular amount and then isolating it while drying, preferably using a fluidized bed dryer.

The present invention therefore provides a nitrile rubber containing at least one substituted phenol of the general formula (1) in an amount in the range from 0.25 to <0.9% by weight, preferably from 0.3 to 0.85% by weight, more preferably from 0.4% by weight to 0.85% by weight, even more preferably 0.4 to less than or equal to 0.81% by weight and most preferably 0.45 to less than or equal to 0.81% by weight, based in each case on the nitrile rubber.

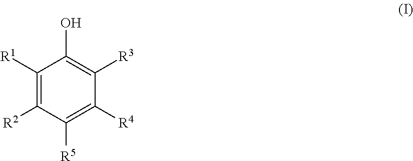

in which
R¹, R², R³, R⁴ and R⁵ are the same or different and are each hydrogen, hydroxyl, a linear, branched, cyclic or aromatic hydrocarbyl radical having 1 to 8 carbon atoms and additionally one, two or three heteroatoms, which are preferably oxygen, where at least one of the R¹, R², R³, R⁴ and R⁵ radicals is not hydrogen.

The present invention further provides vulcanizable mixtures of these inventive nitrile rubbers and processes for producing vulcanizates based thereon, and also the vulcanizates obtainable therewith, especially in the form of shaped bodies.

The present invention further provides a process for producing these inventive nitrile rubbers containing at least one substituted phenol of the general formula (I) in an amount in the range from 0.25 to <0.9% by weight, preferably from 0.3 to 0.85% by weight, more preferably from 0.4% by weight to 0.85% by weight, even more preferably 0.4 to less than or equal to 0.81% by weight and most preferably 0.45 to less than or equal to 0.81% by weight, based in each case on the nitrile rubber, characterized in that
(1) the nitrile rubber is prepared by emulsion polymerization of at least one conjugated diene, at least one α,β-unsaturated nitrile and no further copolymerizable monomer or one or more further copolymerizable monomers.
(2) the resulting suspension of the nitrile rubber in an aqueous medium is admixed with at least one substituted phenol of the general formula. (I), preferably in an amount in the 0.9 to 1.6% by weight, based on the nitrile rubber.

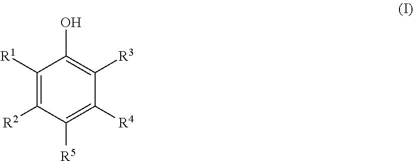

in which
   R¹, R², R³, R⁴ and R⁵ are the same or different and are each hydrogen, hydroxyl, a linear, branched, cyclic or aromatic hydrocarbyl radical having 1 to 8 carbon atoms and additionally having one, two or three heteroatoms, which are preferably oxygen, where at least one of the R¹, R², R³, R⁴ and R⁵ radicals is not hydrogen, and
(3) the nitrile rubber is coagulated, isolated and dried,

characterized in that the drying is effected at a temperature in the range from 100 to 180° C., preferably at 110 to 150° C., and the content of substituted phenol is adjusted to the amount in the range from 0.25 to <0.9% by weight, preferably from 0.3 to 0.85% by weight, more preferably from 0.4% by weight to 0.85% by weight, even more preferably 0.4 to less than or equal to 0.81% by weight and most preferably 0.45 to less than or equal to 0.81% by weight, based in each case on the nitrite rubber.

It is a feature of the rubber of the invention that the vulcanizable mixtures based thereon have improved processing reliability in the form of a prolonged scorch time (“Mooney scorch”), which is determined with the aid of a shearing disc viscometer to DIN 53 523 at 120° C. At the same time, the vulcanizible mixtures based on the inventive nitrile rubber exhibit a higher vulcanization rate (t₉₀-t₁₀) and, in the vulcanized state, an improved modulus value at 300% elongation and elongation at break ε_{B}. The standards by which the properties specified are measured are listed in the Examples section of this application.

Inventive Nitrite Rubbers:

The inventive nitrile rubber contains at least one substituted phenol of the general formula (I)

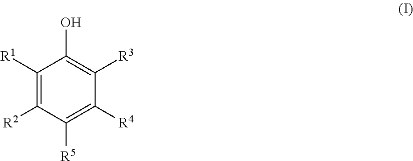

in which
R¹, R², R³, R⁴ and R⁵ are the same or different and are each hydrogen, hydroxyl, a linear, branched, cyclic or aromatic hydrocarbyl radical having 1 to 8 carbon atoms and additionally having one, two or three heteroatoms, which are preferably oxygen, where at least one of the R¹, R², R³, R⁴ and R⁵ radicals is not hydrogen,

in an amount in the range from 0.25 to <0.9% by weight, preferably from 0.3 to 0.85% by weight, more preferably from 0.4% by weight to 0.85% by weight, even more preferably 0.4 to less than or equal to 0.81% by weight and most preferably 0.45 to less: than or equal to 0.81% by weight, based on the nitrile rubber.

Preferably, the inventive nitrile rubber contains substituted phenols of the general formula (I) in which
R¹, R², R³, R⁴ and R⁵ are the same or different and are each hydrogen, hydroxyl, a linear or branched C₁-C₈ alkyl radical, more preferably methyl, ethyl, propyl, n-butyl or t-butyl, a linear or branched C₁-C₈ alkoxy radical, more preferably methoxy, ethoxy or propoxy, a C₅-C₈ cycloalkyl radical, more preferably cyclopentyl cyclohexyl, or a phenyl radical, where at least one of the R¹, R², R³, R⁴ and R⁵ radicals is not hydrogen.

Especially preferably, the inventive nitrile rubber is stabilized using substituted phenols of the general formula (I), in which two or three of the R¹, R², R³, R⁴ and R⁵ radicals are hydrogen and the other two or three of the R¹, R², R³, R⁴ and R⁵ radicals are the same or different and are each hydroxyl, a linear or branched C₁-C₈ alkyl radical, more preferably methyl, ethyl, propyl, n-butyl aar t-butyl, a linear or branched C₁-C₈ alkoxy radical, more preferably methoxy, ethoxy or propoxy, a C₃-C₈ cycloalkyl radical, more preferably cyclopentyl or cyclohexyl, or a phenyl radical.

Most preferably, it is possible to use substituted phenols of the general formula (I) selected from the group consisting of the following compounds:

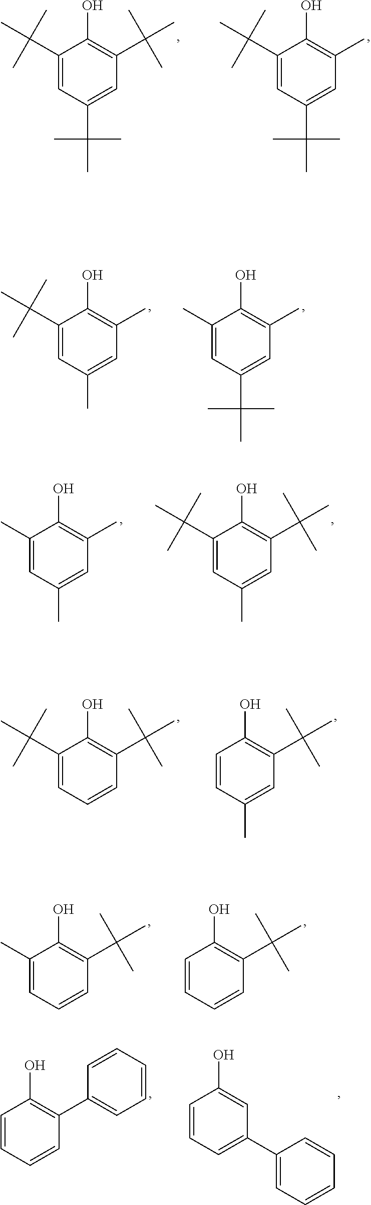

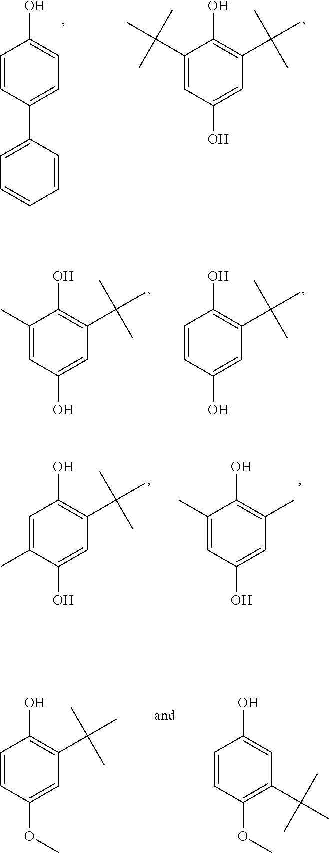

The substituted phenols present in the inventive nitrile rubbers are known, fir example, from DE-A 2150639 and DE 3337567 A1 and are either commercially available or are preparable by methods familiar to those skilled in the art.

A feature that the compounds of the general formula (I) have in common is that they are volatile in a suitably conducted drying operation, preferably by means of fluidized bed drying, and their content can therefore be adjusted to the essential value in the range from 0.25 to <0.9% by weight, preferably from 0.3 to 0.85% by weight, more preferably 0.4 to 0.85% by weight, even more preferably 0.4 to less than or equal to 0.81% by weight and most preferably 0.45 to less than or equal to 0.81% by weight, based on the nitrile rubber. This adjustment is possible for the person skilled in the art by known methods.

In addition to the phenols of the general formula (I) that are steam-volatile, it is also possible to use one or more further aging stabilizers, especially including those that are not steam-volatile.

Repeating Units of the Nitrile Rubber:

The inventive nitrile rubbers have repeating units of at least one α,β-unsaturated nitrile monomer and at least one conjugated diene monomer. They may additionally have repeating units of one or more further copolymerizable monomers.

The repeating units of the at least one conjugated diene are preferably based on (C₄-C₆) conjugated dienes or mixtures thereof. Particular preference is given to 1,2-butadiene, 1,3-butadiene, isoprene, 2,3-dimethylbutadiene, piperylene and mixtures thereof. Especially preferred are 1,3-butadiene, isoprene and mixtures thereof. Even more preferred is 1,3-butadiene.

The α,β-unsaturated nitrile used for production of the inventive nitrile rubbers may be any known α,β-unsaturated nitrile, preference being given to (C₃C₅)-α,β-unsaturated nitriles such as acrylonitrile, methacrylonitrile, ethacrylonitrile or mixtures thereof. Particular preference is given to acrylonitrile.

If one or more further copolymerizable monomers are used, these may, for example, be aromatic vinyl monomers, preferably styrene, α-methylstyrene and vinylpyridine, fluorinated vinyl monomers, preferably fluoroethyl vinyl ether, fluoropropyl vinyl ether, o-fluoromethylstyrene, vinyl pentafluorobenzoate difluoroethylene and tetrafluoroethylene, or else copolymerizable antiaging monomers, preferably N-(4-anilinophenyl)acrylamide, N-(4-anilinophenyl)methacrylamide, N-(4-anilinophenyl)cinnamides, N-(4-anilinophenyl)crotonamide, N-phenyl-4-(3-vinylbenzyloxy)aniline and N-phenyl-4-(4-vinylbenzyloxy)aniline, and also nonconjngated dienes, such as 4-cyanocyclohexene and 4-vinylcyclohexene, or else alkynes such as 1- or 2-butyne.

In addition, the copolymerizable termonomers used may be monomers containing hydroxyl groups, preferably hydroxyalkyl (meth)acrylates. It is also possible to use correspondingly substituted (meth)acrylamides.

Examples of suitable hydroxyalkyl acrylate monomers are 2-hydroxyethyl (meth)acrylate, 2-hydroxypropyl (meth)acrylate, 3-hydroxypropyl (meth)acrylate, 3-chloro-2-hydroxypropyl (meth)acrylate, 3-phenoxy-2-hydroxypropyl (meth)acrylate, glyceryl mono(meth)acrylate, hydroxybutyl (meth)acrylate, 3-chloro-2-hydroxypropyl (meth)acrylate, hydroxyhexyl (meth)acrylate, hydroxyoctyl (meth)acrylate, hydroxymethyl(meth)acrylamide, 2-hydroxypropyl (meth)acrylate, 3-hydroxypropyl(meth)acrylamide, di(ethylene glycol) itaconate, di(propylene glycol) itaconate, bis(2-hydroxypropyl) itaconate, bis(2-hydroxyethyl) itaconate, bis(2-hydroxyethyl) fumarate, bis(2-hydroxyethyl) maleate and hydroxymethyl vinyl ketone.

In addition, the copolymerizable termonomers used may be monomers containing epoxy groups, preferably glycidyl(meth)acrylates.

Examples of monomers containing epoxy groups are diglycidyl itaconate, glycidyl p-styrenecarboxylate, 2-ethylglycidyl acrylate, 2-ethylglycidyl methacrylate, 2-(n-propyl)glycidyl acrylate, 2-(n-propyl)glycidyl methacrylate, 2-(n-butyl)glycidyl acrylate, 2-(n-butyl)glycidyl methacrylate, glycidylmethyl acrylate, glycidylmethyl acrylate, glycidyl acrylate, (3′,4′-epoxyheptyl)-2-ethyl acrylate, (3′,4′-epoxyheptyl)-2-ethyl methacrylate, 6′,7′-epoxyheptyl acrylate, 6′,7′-epoxyheptyl methacrylate, allyl glycidyl ether, allyl 3,4-epoxyheptyl ether, 6,7-epoxyheptyl allyl ether, vinyl glycidyl ether, vinyl 3,4-epoxyheptyl ether, 3,4-epoxyheptyl vinyl ether, 6,7-epoxyheptyl vinyl ether, o-vinylbenzyl glycidyl ether, m-vinylbenzyl glycidyl ether, p-vinylbenzyl glycidyl ether and 3-vinylcyclohexene oxide.

Alternatively, further copolymerizable monomers used may be copolymerizable termonomers containing carboxyl groups, for example α,β-unsaturated monocarboxylic acids, esters thereof, α,β-unsaturated dicarboxylic acids, mono- or diesters thereof or the corresponding anhydrides or amides thereof.

The α,β-unsaturated monocarboxylic acids used may preferably be acrylic acid and methacrylic acid.

It is also possible to use esters of the α,β-unsaturated monocarboxylic adds, preferably the alkyl esters and alkoxyalkyl esters thereof. Preference is given to the alkyl esters, especially C₁-C₁₈ alkyl esters, of the α,β-unsaturated monocarboxylic acids, particular preference to alkyl esters, especially C₁-C₁₈alkyl esters of acrylic acid or of methacrylic acid, especially methyl acrylate, ethyl acrylate, propyl acrylate, n-butyl acrylate, tert-butyl acrylate, 2-ethylhexyl acrylate, n-dodecyl acrylate, methyl methacrylate, ethyl methacrylate, butyl methacrylate and 2-ethylhexyl methacrylate. Preference is also given to alkoxyalkyl esters of the aα,β-unsaturated monocarboxylic acids, particular preference to alkoxyalkyl esters of acrylic acid or of methacrylic acid, especially C₂-C₁₂-alkoxyalkyl esters of acrylic acid or of methacrylic acid, even more preferably methoxymethyl acrylate, methoxyethyl (meth)acrylate, ethoxyethyl (meth)acrylate and methoxyethyl (meth)acrylate. It is also possible to use mixtures of alkyl esters, for example those mentioned above, with alkoxyalkyl esters, for example in the form of those mentioned above. It is also possible to use cyanoalkyl acrylate and cyanoalkyl methacrylates in which the number of carbon atoms in the cyanoalkyl group is 2-12, preferably α-cyanoethyl acrylate, β-cyanoethyl acrylate and cyanobutyl methacrylate. It is also possible to use hydroxyalkyl acrylates and hydroxyalkyl methacrylates in which the number of carbon atoms of the hydroxyalkyl groups is 1-12, preferably 2-hydroxyethyl acrylate, 2-hydroxyethyl methacrylate and 3-hydroxypropyl acrylate; it is also possible to use acrylates or methacrylates containing fluorine-substituted benzyl groups, preferably fluorobenxyl acrylate and fluorobenzyl methacrylate. It is also possible to use acrylates and methacrylates containing fluoroalkyl groups, preferably trifluoroethyl acrylate and tetrafluoropropyl methacrylate. It is also possible to use α,β-unsaturated carboxylic esters containing amino groups, such as dimethylaminomethyl acrylate and diethylaminoethyl acrylate.

Further monomers used may be α,β-unsaturated dicarboxylic acids, preferably maleic acid, fumaric acid, crotonic acid, itaconic acid, citraconic arid and mesaconic acid.

It is additionally possible to use α,β-unsaturated dicarboxylic anhydrides, preferably maleic anhydride, itaconic anhydride, citraconic anhydride and mesaconic anhydride.

It is additionally possible to use mono- or diesters of α,β-unsaturated dicarboxylic acids.

These aα,β-unsaturated dicarboxylic mono- or diesters may, for example, be alkyl, preferably C₁-C₁₀-alkyl, especially ethyl, n-propyl, isopropyl, n-butyl, tert-butyl, n-pentyl or n-hexyl, alkoxyalkyl, preferably C₂-C₁₂-alkoxyalkyl, more preferably C₃-C₈-alkoxyalkyl, hydroxyalkyl, preferably C₁-C₁₂-hydroxyalkyl, more preferably C₂-C₈-hydroxyalkyl, cycloalkyl, preferably C₅-C₁₂-cycloalkyl, more preferably C₆-C₁₂-cycloalkyl, alkylcycloalkyl, preferably C₆-C₁₂-alkylcycloalkyl, more preferably C₇-C₁₀-alkylcycloalkyl, aryl, preferably C₆-C₁₄-aryl, mono- or diesters, where any diesters may also be mixed esters.

Particularly preferred alkyl esters of α,β-unsaturated monocarboxylic acids are methyl (meth)acrylate, ethyl (meth)acrylate, propyl (meth)acrylate, n-butyl (meth)acrylate, t-butyl (meth)acrylate, hexyl (meth)acrylate, 2-ethylhexyl (meth)acrylate, octyl (meth)acrylate, 2-propylheptyl acrylate and lauryl (meth)acrylate. In particular, n-butyl acrylate is used.

Particularly preferred alkoxyalkyl esters of the α,β-unsaturated monocarboxylic acids are methoxyethyl (meth)acrylate, ethoxyethyl (meth)acrylate and methoxyethyl (meth)acrylate. In particular, methoxyethyl acrylate is used.

Other esters of the α,β-unsaturated monocarboxylic acids used are additionally, for example, polyethylene glycol (meth)acrylate, polypropylene glycol (meth)acrylate, N-(2-hydroxyethyl)acrylamides, N-(2-hydroxymethyl)acrylamides and urethane (meth)acrylate.

Examples of α,β-unsaturated dicarboxylic monoesters include
monoalkyl maleates, preferably monomethyl maleate, monoethyl maleate, monopropyl maleate and mono-n-butyl maleate;
monocycloalkyl maleates, preferably monocyclopentyl maleate, monocyclohexyl maleate and monocycloheptyl maleate;
monoalkylcycloalkyl maleates, preferably monomethylcyclopentyl maleate and monoethylcyclohexyl maleate;
monoaryl maleates, preferably monophenyl maleate;
monobenzyl maleates, preferably monobenzyl maleate;
monoalkyl fumarates, preferably monomethyl fumarate, monoethyl fumarate, monopropyl fumarate and mono-n-butyl fumarate;
monocycloalkyl fumarates, preferably monocyclopentyl fumarate, monocyclohexyl fumarate and monocycloheptyl fumarate;
monoalkylcycloalkyl fumarates, preferably monomethylcyclopentyl fumarate and monoethylcyclohexyl fumarate;
monoaryl fumarates, preferably monophenyl fumarate;
monobenzyl fumarates, preferably monobenzyl fumarate;
monoalkyl citraconates, preferably monomethyl citraconate, monoethyl citraconate, monopropyl citraconate and mono-n-butyl citraconate;
monocycloalkyl citraconates, preferably monocyclopentyl citraconate, monocyclohexyl citraconate and monocycloheptyl citraconate;
monoalkylcycloalkyl citraconates, preferably monomethylcyclopentyl citraconate and monoethylcyclohexyl citraconate;
monoaryl citraconates, preferably monophenyl citraconate;
monobenzyl citraconates, preferably monobenzyl citraconate;
monoalkyl itaconates, preferably monomethyl itaconate, monoethyl itaconate, monopropyl itaconate and mono-n-butyl itaconate;
monocycloalkyl itaconates, preferably monocyclopentyl itaconate, monocyclohexyl itaconate and monacycloheptyl itaconate;
monoalkylcycloalkyl itaconates, preferably monomethylcyclopentyl itaconate and monoethylcyclohexyl itaconate;
monoaryl itaconates, preferably monophenyl itaconate;
monobenzyl itaconates, preferably monobenzyl itaconate;
monoalkyl mesaconates, preferably monoethyl mesaconate.

The α,β-intsaturated dicarboxylic diesters used may be the analogous diesters based on the aforementioned monoester groups, where the ester groups may also be chemically different groups.

Useful further copolymerizable monomers are additionally free-radically polymerizable compounds containing at least two olefinic double bonds per molecule. Examples of polyunsaturated compounds are acrylates, methacrylates or itaconates of polyols, for example ethylene glycol diacrylate, diethylene glycol dimethacrylate, triethylene glycol diacrylate, butane-1,4-diol diacrylate, propane-1,2-diol diacrylate, butane-1,3-diol dimethacrylate, neopentyl glycol diacrylate, trimethylolpropane di(meth)acrylate, trimethylolethane di(meth)acrylate, glyceryl di- and triacrylate, pentaerythrityl di-, tri- and tetraacrylate or -methacrylate, dipentaerythrityl tetra-, penta- and hexaacrylate or -methacrylate or -itaconate, sorbityl tetraacrylate, sorbityl hexamethacrylate, diacrylates or dimethacrylates of 1,4-cyclohexanediol, 1,4-dimethylolcyclohexane, 2,2-bis(4-hydroxyphenyl)propane, of polyethylene glycols or of oligoesters or oligourethanes with terminal hydroxyl groups. The polyunsaturated monomers used may also be acrylamides, for example methylenebisacrylamide, hexamethylene-1,6-bisacrylamide, diethylenetriaminetrismethacrylamide, bis(methacrylamidopropoxy)ethane or 2-acrylamidoethyl acrylate. Examples of polyunsaturated vinyl and allyl compounds are divinylbenzene, ethylene glycol divinyl ether, diallyl phthalate, allyl methacrylate, diallyl maleate, triallyl isocyanurate or triallyl phosphate.

The proportions of conjugated diene and α,β-unsaturated nitrile in the inventive nitrile rubbers may vary within wide ranges. The proportion of, or the sum total of, the conjugated diene(s) is typically in the range from 20 to 95% by weight, preferably in the range from 45 to 90% by weight, more preferably in the range from 50 to 85% by weight, based on the overall polymer. The proportion of, or the sum total of, the α,β-unsaturated nitrile(s) is typically in the range from 5 to 80% by weight, preferably 10 to 55% by weight, more preferably 15 to 50% by weight, based on the overall polymer. The proportions of the repeating units of conjugated diene and α,β-unsaturated nitrile in the inventive nitrile rubbers add up to 100% by weight in each case.

The additional monomers may be present in amounts of 0 to 40% by weight, preferably 0 to 30% by weight, more preferably 0 to 26% by weight, based on the overall polymer. In this case, corresponding proportions of the repeating units of the conjugated diene(s) and/or of the repeating units of the α,β-unsaturated nitrile(s) are replaced by the proportions of these additional monomers, where the proportions of all the repeating units of the monomers must also add up to 100% by weight in each case.

If esters of (meth)acrylic acid are used as additional monomers, this is typically done in amounts of 1 to 25% by weight. If α,β-unsaturated mono- or dicarboxylic acids are used as additional monomers, this is typically done in amounts of less than 10% by weight.

Preference is given to inventive nitrile rubbers having repeating units of acrylonitrile, and 1,3-butadiene. Preference is further given to nitrile rubbers having repeating units of acrylonitrile, 1,3-butadiene and one or more further copolymerizable monomers. Preference is likewise given to nitrile rubbers having repeating units of acrylonitrile, 1,3-butadiene and one or more α,β-unsaturated mono- or dicarboxylic acids or esters or amides thereof, and especially repeating units of an alkyl ester of an α,β-unsaturated carboxylic acid, most preferably of methyl (meth)acrylate, ethyl (meth)acrylate, propyl (meth)acrylate, n-butyl (meth)acrylate, t-butyl (meth)acrylate, hexyl (meth)acrylate, 2-ethythexyl (meth)acrylate, octyl (meth)acrylate or lauryl (meth)acrylate.

The nitrogen content is determined in the inventive nitrile rubbers to DIN 53 625 according to Kjeldahl. Due to the content of polar comonomers, the nitrile rubbers are typically ≧85% by weight soluble in methyl ethyl ketone at 20° C.

The glass transition temperatures of the inventive nitrile rubbers are within the range of −70° C. to +10° C., preferably within the range of −60° C. to 0° C.

The nitrile rubbers have Mooney viscosities ML 1+4 at 100° C. of 10 to 150 Mooney units (MU), preferably of 20 to 100 MU.

The Mooney viscosity of the nitrile rubbers is determined in a shearing disc viscometer to DIN 53523/3 or ASTM D 1646 at 1000° C. This involves analysing each of the unvulcanized rubbers after drying and before aging. The Mooney viscosities of the nitrile rubbers or of the hydrogenated nitrile rubbers after drying and before aging are referred to hereinafter as MV 0.

To determine the storage stability of the unvulcanized nitrile rubbers or of the unvulcanized hydrogenated nitrile rubbers, the Mooney viscosities are determined.

The Mooney viscosity values determined after storage of the of the nitrile rubber at 100° C. for 48 hours are referred to as MV 1. The storage stability (SS) is determined as the difference between the Mooney viscosity values after and before hot air storage:

SS 1(48 h/100° C.)=MV 1−MV 0

The storage stability of nitrile rubber is good when the Mooney viscosity changes by not more than 5 Mooney units in the course of storage at 100° C. for 48 hours (SS=MV 1−MV 0).

To determine the Mooney viscosities, for the purpose of calculating the storage stability according to the above formulae, it has been found to be useful to produce milled sheets of the nitrile rubbers. Typically, these milled sheets are obtained by rolling out 100 g of the particular rubber at room temperature in a conventional roll mill (e.g. Schwabenthan Polymix 110) at a gap width of 0.8-1.0 mm. The rotational speeds are 25 min⁻¹/30 min⁻¹. Rectangular sections (40-50 g) are produced from the sheets and stored in an air circulation drying cabinet on aluminium dishes (10 cm/15 cm) with the base covered with Teflon film. The oxygen content in this air circulation drying cabinet is unchanged from normal air.

Process for Producing the Inventive Nitrile Rubbers:

The preparation of these inventive nitrile rubbers containing at least one substituted phenol of the general formula (I)

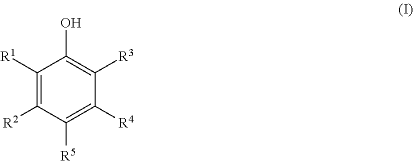

in which
R¹, R², R³, R⁴ and R⁵ are the same or different and are each hydrogen, hydroxyl, a linear, branched, cyclic or aromatic hydrocarbyl radical having 1 to 8 carbon atoms and additionally having one, two or three heteroatoms, which are preferably oxygen, where at least one of the R¹, R², R³, R⁴ and R⁵ radicals is not hydrogen.

in an amount in the range from 0.25 to <0.9% by weight, preferably from 0.3 to 0.85% by weight, more preferably from 0.4% by weight to 0.85% by weight, even more preferably 0.4 to less than or equal to 0.81% by weight and most preferably 0.45 to less than or equal to 0.81% by weight, based on the nitrile rubber, is effected by
(1) preparing the nitrile rubber by emulsion polymerization of at least one conjugated diene, at least one α,β-unsaturated nitrile and no further copolymerizable monomer or one or more further copolymerizable monomers,
(2) admixing the resulting suspension of the nitrile rubber in an aqueous medium with at least one substituted phenol of the general formula (I), preferably in an amount in the range from 0.9 to 1.6% by weight, based on the nitrile rubber, and
(3) coagulating, isolating and drying the nitrile rubber,

characterized in that the drying is effected at a temperature in the range from 100 to 180° C., preferably at 110 to 150° C. and the content of substituted phenol of the general formula (1) is adjusted to the amount in the range from 0.25 to <0.9% by weight, preferably from 0.3 to 0.85% by weight, more preferably from 0.4% by weight to 0.85% by weight, even more preferably 0.4 to less than or equal to 0.81% by weight and most preferably 0.45 to less than or equal to 0.81% by weight, based in each case on the nitrile rubber.

Step 1:

The nitrile rubber is typically prepared via an emulsion polymerization to form a suspension of the nitrile rubber in an aqueous medium. This is typically referred to as the formation of a nitrile rubber latex. Emulsion polymerization is sufficiently well known to those skilled in the art and is described extensively in the literature.

Emulsion polymerizations are conducted with use of emulsifiers. For this purpose, a wide range of emulsifiers is known and available to those skilled in the art. Emulsifiers used may, for example, be anionic emulsifiers or else uncharged emulsifiers. Preference is given to using anionic emulsifiers, more preferably in the form of water-soluble salts.

Anionic emulsifiers used may be modified resin acids which are obtained by dimerization, disproportionation, hydrogenation and modification of resin acid mixtures comprising abietic acid, neoabietic acid, palustric acid, levopimaric acid. A particularly preferred modified resin acid is disproportionated resin acid (Ullmann's Encyclopedia of Industrial Chemistry, 6th edition, volume 31, p. 345-355).

Anionic emulsifiers used may also be fatty adds. These contain 6 to 22 carbon atoms. They may be fully saturated or contain one or more double bonds in the molecule. Examples of fatty acids are caproic acid, lauric acid, myristic acid, palmitic acid, stearic acid, oleic acid, linoleic acid, linolenic acid. The carboxylic acids are typically based on origin-specific oils or fats, for example castor oil, cottonseed, peanut oil, linseed oil, coconut fat, palm kernel oil, olive oil, rapeseed oil, soya oil, fish oil and bovine tallow etc. (Ullmann's Encyclopedia of Industrial Chemistry, 6th edition, volume 13, p. 75-108). Preferred carboxylic acids derive from coconut fatty acid and from bovine tallow, and are partly or fully hydrogenated. Such carboxylic acids based on modified resin acids or fatty acids are used in the form of water-soluble lithium, sodium, potassium and ammonium salts. Sodium salts and potassium salts are preferred.

Suitable anionic emulsifiers are also sulphonates, sulphates and phosphates bonded to an organic radical. Useful organic radicals include aliphatic, aromatic, alkylated aromatic systems, fused aromatic systems, and methylene-bridged aromatic systems, where the methylene-bridged and fused aromatic systems may additionally be alkylated. The length of the alkyl chains is 6 to 25 carbon atoms. The length of the alkyl chains bonded to the aromatic systems is between 3 and 12 carbon atoms.

The sulphates, sulphonates and phosphates are used in the form of lithium salts, sodium salts, potassium salts and ammonium salts. The sodium salts, potassium salts and ammonium salts are preferred.

Examples of sulphonates, sulphates and phosphates of this kind are sodium laurylsulphate, sodium alkylsulphonate, sodium alkylarylsulphonate, sodium salts of methylene-bridged arylsulphonates, sodium salts of alkylated naphthalenesulphonates, and the sodium salts of methylene-bridged naphthalenesulphonates, which may also be oligomerized, where the oligomerization level is between 2 and 10. Typically, the alkylated napthalenesulphonic acids and the methylene-bridged (and optionally alkylated) naphthalenesulphonic acids are in the form of isomer mixtures which may also contain more than 1 sulphonic acid group (2 to 3 sulphonic acid groups) in the molecule. Particular preference is given to sodium laurylsulphate, sodium alkylsulphonate mixtures having 12 to 18 carbon atoms, sodium alkylarylsulphonates, sodium diisobutylenenaphthalenesulphonate, methylene-bridged polynaphthalenesulphonate mixtures and methylene-bridged arylsulphonate mixtures.

Uncharged emulsifiers derive from addition products of ethylene oxide and propylene oxide onto compounds having sufficiently acidic hydrogen. These include, for example, phenol, alkylated phenol and alkylated amines. The mean polymerization levels of the epoxides are between 2 and 20. Examples of uncharged emulsifiers are ethoxylated nonylphenols having 8, 10 and 12 ethylene oxide units. The uncharged emulsifiers are typically not used alone, but in combination with anionic emulsifiers.

Preference is given to the sodium and potassium salts of disproportionated abietic acid and partly hydrogenated tallow fatty acid, and mixtures thereof, sodium laurylsulphate, sodium alkylsulphonates sodium alkylbenzenesulphonate and alkylated and methylene-bridged naphthalenesulphonic acids.

The emulsifiers are used in an amount of 0.2 to 15 parts by weight, preferably 0.5 to 12.5 parts by weight, more preferably 1.0 to 10 parts by weight, based on 100 parts by weight of the monomer mixture.

The emulsion polymerization is conducted using the emulsifiers mentioned. If, on completion of the polymerization, latices having a tendency to premature self-coagulation because of a certain instability are obtained, said emulsifiers can also be added for post-stabilization of the latices. This may become necessary particularly prior to the removal of unconverted monomers by treatment with steam and before any storage of latex.

For molecular weight regulation of the nitrile rubber which forms, at least one molecular weight regulator is used. The regulator is typically used in an amount of 0.01 to 3.5 parts by weight, preferably of 0.05 to 3 parts by weight, more preferably 0.1 to 2.5 parts by weight, especially 0.1 to 1.5 parts by weight, based on 100 parts by weight of the monomer mixture.

The molecular weight can be adjusted using mercaptan-containing carboxylic acids, mercaptan-containing alcohols, xanthogen disulphides, thiuram disulphides, halogenated hydrocarbons, branched aromatic or aliphatic hydrocarbons, or else linear or branched mercaptans. These compounds typically have 1 to 20 carbon atoms (see Rubber Chemistry and Technology (1976), 49(3), 610-49 (Uraneck, C. A.): “Molecular weight control of elastomers prepared by emulsion polymerization” and D. C. Blackley, Emulsion Polymerization, Theory and Practice, Applied Science Publishers Ltd London, 1975, p, 329-381).

Examples of mercaptan-containing alcohols and mercaptan-containing carboxylic acids are monothioethylene glycol and mercaptopropionic acid.

Examples of xanthogen disulphides are dimethylxanthogen disulphide, diethylxanthogen disulphide and diisopropylxanthogen disulphide.

Examples of thiuram disulphides are tetramethylthiuram disulphide, tetraethylthiuram disulphide and tetrabutylthiuram disulphide.

Examples of halogenated hydrocarbons are carbon tetrachloride, chloroform, methyl iodide, diiodomethane, difluorodiiodomethane, 1,4-diiodobutane, 1,6-diiodohexane, ethyl bromide, ethyl iodide, 1,2-dibromotetrafluoroethane, bromotrifluoroethene, bromodifluoroethene.

Examples of unbranched hydrocarbons are those from which an H radical can readily be eliminated. Examples thereof are toluene, ethylbenzene, cumene, pentaphenylethane, triphenylmethane, 2,4-diphenyl-4-methyl-1-pentene, dipentene, and terpenes, for example limonene, α-pinene, β-pinene, α-carotene and β-carotene.

Examples of linear or branched mercaptans are n-hexyl mercaptan or else mercaptans containing 12-16 carbon atoms and at least three tertiary carbon atoms, where the sulphur is bonded to one of these tertiary carbon atoms. These mercaptans are preferred and can be used either individually or in mixtures. Suitable examples are the addition compounds of hydrogen sulphide onto oligomerized propene, especially tetrameric propene, or onto oligomerized isobutene, especially trimeric isobutane, which are frequently referred to in the literature as tertiary dodecyl mercaptan (“t-DDM”).

Such alkyl thiols or (isomer) mixtures of alkyl thiols are either commercially available or else are preparable by the person skilled in the art by processes that have been sufficiently well described in the literature (see, for example, JP 07-316126, JP 07-316127 and JP 07-316128, and also GB 823,823 and GB 823,824). A further example of an alkyl thiol is 2,2,4,6,6,8,8-pentamethylheptane-4-thiol.

It is also possible to use a mixture of C₁₂ mercaptans containing
2,2,4,6,6-pentamethylheptane-4-thiol,
2,4,4,6,6-pentamethylheptane-2-thiol,
2,3,4,6,6-pentamethylheptane-2-thiol and
2,3,4,6,6-pentamethylheptane-3-thiol,

which are described together with a process for preparation thereof in the German patent application DE 102007024009.

The molecular weight regulator or molecular weight regulator mixture is metered in either on commencement of the polymerization or else in portions in the course of the polymerization, preference being given to addition of all the components or of individual components of the regulator mixture in portions during the polymerization.

Because of its function, the molecular weight regulator is found to a certain degree in the form of end groups in the nitrile rubber, if, for example, an alkyl thiol or a mixture of alkyl thiols is used, the nitrile rubber has alkylthio end groups to a certain degree. If the above-described specific mixture of C₁₂ mercaptans is used, these end groups are thus the corresponding thio end groups of the thiols present in the regulator mixture, i.e. 2,2,4,6,6-pentamethylheptane4-thio and/or 2,4,4,6,6-pentamethylheptane-2-thio and/or 2,3,4,6,6-pentamethylheptane-2-thio and/or 2,3,4,6,6-pentamethylheptane3-thio. Preferably, a nitrile rubber of this kind contains 2,2,4,6,6-pentamethylheptane-4-thio, 2,4,4,6,6-pentamethylheptane-2-thio, 2,3,4,6,6-pentamethylheptane-2-thio and 2,3,4,6,6-pentamethylheptane-3-thio end groups.

The emulsion polymerization is typically initiated using polymerization initiators which break down to free radicals (free-radical polymerization initiators). These include compounds containing an —O—O— unit (peroxo compounds) or an —N≡N— unit (azo compound).

Suitable peroxo compounds are hydrogen peroxide, peroxodisulphates peroxodiphosphates, hydroperoxides, peracids, peresters, peracid anhydrides and peroxides having two organic radicals. Suitable salts of peroxodisulphuric acid and peroxodiphosphoric acid are the sodium, potassium and ammonium salts. Suitable hydroperoxides are, for example, t-butyl hydroperoxide, cumene hydroperoxide and p-menthane hydroperoxide. Suitable peroxides having two organic radicals are dibenzoyl peroxide, 2,4-dichlorobenzoyl peroxide, di-t-butyl peroxide, dicumyl peroxide, t-butyl perbenzoate, t-butyl peracetate etc. Suitable azo compounds are azobisisobutyronitrile, azobisvaleronitrile and azobiscyclohexanenitrile.

Hydrogen peroxide, hydroperoxides, peracids, peresters, peroxodisulphate and peroxodiphosphate are also used in combination with reducing agents. Suitable reducing agents are sulphenates, sulphinates, sulphoxylates, dithionite, sulphite, metabisulphite, disulphite, sugar, urea, thiourea, xanthogenates, thioxanthogenates, hydrazinium salts, amines and amine derivatives such as aniline, dimethylaniline, monoethanolamine, diethanolamine or triethanolamine. Initiator systems consisting of an oxidizing agent and a reducing agent are referred to as redox systems. In the case of use of redox systems, salts of transition metal compounds such as iron, cobalt or nickel are frequently additionally used in combination with suitable complexing agents such as sodium ethylenediaminetetraacetate, sodium nitrilotriacetate and trisodium phosphate or tetrapotassium diphosphate.

Preferred redox systems are, for example: 1) potassium peroxodisulphate in combination with triethanolamine, 2) ammonium peroxodiphosphate in combination with sodium metabisulphite (Na₂S₂O₅), 3) p-menthane hydroperoxide/sodium formaldehydesulphoxylate in combination with iron(II) sulphate (FeSO₄×7 H₂O), sodium ethylenediaminoacetate and trisodium phosphate; 4) cumene hydroperoxide/sodium formaldehydesulphoxylate in combination with iron(II) sulphate (FeSO₄×7 H₂O), sodium ethylenediaminoacetate and tetrapotassium diphosphate.

The amount of oxidizing agents is 0.001 to 1 part by weight based on 100 parts by weight of monomer. The molar amount of reducing agent is between 50% and 500% based on the molar amount of the oxidizing agent used.

The molar amount of complexing agent is based on the amount of transition metal used and is typically equimolar therewith.

To conduct the polymerization, all or individual components of the initiator system are metered in at the start of the polymerization or during the polymerization.

Addition of all and individual components of the activator system in portions during the polymerization is preferred. Sequential addition can be used to control the reaction rate.

The amount of water used in the emulsion polymerization is in the range from 100 to 900 parts by weight, preferably in the range from 120 to 500 parts by weight and more preferably in the range from 150 to 400 parts by weight of water, based on 100 parts by weight of the monomer mixture.

To reduce the viscosity during the polymerization, to adjust the pH, and as a pH buffer, salts can be added to the aqueous phase in the course of the emulsion polymerization. Typical salts are salts of monovalent metals in the form of potassium hydroxide and sodium hydroxide, sodium sulphate, sodium carbonate, sodium hydrogencarbonate, sodium chloride and potassium chloride. Preference is given to sodium hydroxide or potassium hydroxide, sodium hydrogencarbonate and potassium chloride. The amounts of these electrolytes are in the range of 0 to 1 part by weight, preferably 0 to 0.5 part by weight, based on 100 parts by weight of the monomer mixture.

The polymerization can be performed either batchwise or else continuously in a stirred tank cascade.

To achieve homogeneous running of the polymerization, only a portion of the initiator system is used for the start of the polymerization and the rest is metered in during the polymerization. Typically, the polymerization is commenced with 10 to 80% by weight, preferably 30-50% by weight, of the total amount of initiator. It is also possible to subsequently meter in individual constituents of the initiator system.

If the intention is to produce chemically homogeneous products, further acrylonitrile or butadiene is metered in if the composition is outside the azeotropic butadiene/acrylonitrile ratio. Preference is given to subsequent metered addition in the case of NBR types with acrylonitrile contents of 10 to 34% by weight, and in the case of the types with 40 to 50% by weight of acrylonitrile (W. Hofmann, Rubber Chem. Technol, 36 (1963)). The subsequent metered addition is effected—as specified, for example, in DO 154 702—preferably under computer control on the basis of a computer program.

The polymerization time is in the range from 5 h to 15 h and depends essentially on the acrylonitrile content of the monomer mixture and on the polymerization temperature. The polymerization temperature is in the range from 0 to 30° C., preferably in the range from 5 to 25° C.

On attainment of conversions in the range from 50 to 90%, preferably in the range from 60 to 85, the polymerization is stopped. For this purpose, a stopper is added to the reaction mixture. Suitable examples of these are dimethyl dithiocarbamate, sodium nitrite, mixtures of dimethyl dithiocarbamate and sodium nitrite, hydrazine and hydroxylamine and salts derived therefrom, such as hydrazinium sulphate and hydroxylammonium sulphate, diethylhydroxylamine, diisopropylhydroxylamine, water-soluble salts of hydroquinone, sodium dithionite, phenyl-α-naphthylamine and aromatic phenols such as tert-butylcatechol, or phenothiazine.

After the polymerization, the resulting suspension of the nitrile rubber in an aqueous medium is admixed with at least one substituted phenol of the general formula (I), preferably in an amount in the range from 0.9 to 1.6% by weight, based on the nitrile rubber.

The addition of the substituted phenol can also be combined, for example, with one of the aforementioned stoppers and/or combined with a further, non-steam-volatile aging stabilizer. Addition separately from the stopper is also possible, and may precede or follow the addition of the stopper.

It has been found to be useful to add the substituted phenol of the general formula (I) as an aqueous dispersion. The concentration of this aqueous dispersion is typically within a range from 2.50-70% by weight, preferably 5-60% by weight. It is also possible to add the substituted phenol to the monomer-containing latex at the end of the polymerization, either in a solvent or dissolved in monomer (butadiene, acrylonitrile or in a butadiene/acrylonitrile mixture) before the removal of monomers (monomer devolatilization). Addition in butadiene, acrylonitrile or a butadiene/acrylonitrile mixture has been found to be useful, where the concentration of the substituted phenol in the monomer is 0.5-30% by weight, preferably 1-20% by weight.

There is optionally a subsequent monomer devolatilization.

Step 2:

Step 1 is followed by a coagulation of the inventive nitrile rubber. This is sufficiently well known to the person skilled in the art. Preferably, the latex coagulation of the nitrile rubber is effected by the process described in general terms in EP-A-1 369 436. The nitrile rubber crumbs obtained in the coagulation are washed, separated off by means of sieves and subjected to preliminary mechanical dewatering. Subsequently, drying is effected at temperatures of 100 to 180° C., preferably at 110 to 150° C.

Preference is given to drying by means of a fluidized bed drying operation at temperatures of 100 to 180° C., preferably at 110 to 150° C.

A suitable fluidized bed dryer comprises a drying unit in which the nitrile rubber to be dried is applied to trays provided with apertures, preferably in the form of a perforated sheet or slotted sheet, and then subjected to an air flow at a temperature in the range from 100 to 180° C., preferably at 110 to 150° C. The moister output air is discharged from the drying unit. In a further embodiment, the tray provided with apertures can also be made to vibrate, such that the nitrile rubber can be dried with vibration.

In the course of drying, the residual moisture adhering to the crumbs is removed. The workup is conducted in each case such that the substituted phenol of the general formula (I) present in the nitrile rubber is removed to an extent of 20-90% by weight, especially to an extent of 30-80% by weight, based on the amount of the substituted phenol of the general formula (I) in the nitrile rubber.

The inventive nitrile rubber finally obtained has a content of volatile fractions of <1.0% by weight, a gel content of <1% by weight and a content of phenol of the general formula (I) in the range from 0.25 to <0.9% by weight.

Vulcanizable Mixtures, Process for Production Thereof, Vulcanizates and Production Thereof:

The invention further provides vulcanizable mixtures comprising at least one inventive nitrile rubber and at least one crosslinking system. Preferably, these vulcanizable mixtures may also comprise one or more further typical rubber additives.

These vulcanizable mixtures are produced by mixing at least one inventive nitrile rubber (i) and at least one crosslinking system (ii) and optionally one or more further additives.

The crosslinking system comprises at least one crosslinker and optionally one or more crosslinking accelerators.

Typically, the inventive hydrogenated nitrile rubber is first mixed with all the additives selected, and the crosslinking system composed of at least one crosslinker and optionally a crosslinking accelerator is the last to be mixed in.

Useful crosslinkers include, for example, peroxidic crosslinkers such as bis(2,4-dichlorobenzyl) peroxide, dibenzoyl peroxide, bis(4-chlorobenzoyl) peroxide, 1,1-bis(t-butylperoxy)-3,3,5-trimethylcyclohexane, tert-butyl perbenzoate, 2,2-bis(t-butylperoxy)butene, 4,4-di-tert-butyl peroxynonylvalerate, dicumyl peroxide, 2,5-dimethyl-2,5-di(t-butylperoxy)hexane, tert-butyl cumyl peroxide, 1,3-bis(t-butylperoxyisopropyl)benzene, di-t-butyl peroxide and 2,5-dimethyl-2,5-di(t-butylperoxy)-3-hexyne.

It may be advantageous to use, as well as these peroxidic crosslinkers, also further additions which can help to increase the crosslinking yield: suitable examples thereof include triallyl isocyanurate, triallyl cyanurate, trimethylolpropane tri(meth)acrylate, triallyltrimellitate, ethylene glycol dimethacrylate, butanediol dimethacrylate, trimethylolpropane trimethacrylate, zinc diacrylate, zinc dimethacrylate, 1,2-polybutadiene or N,N′-m-phenylenedimaleimide.

The total amount of the crosslinker(s) is typically in the range from 1 to 20 phr, preferably in the range from 1.5 to 15 phr and more preferably in the range from 2 to 10 phr, based on the unhydrogenated or fully or partly hydrogenated nitrile rubber.

The crosslinkers used may also be sulphur in elemental soluble or insoluble form, or sulphur donors.

Useful sulphur donors include, for example, dimorpholyl disulphide (DTDM), 2-morpholinodithiobenzothiazole (MBSS), caprolactam disulphide, dipentamethylenethiuram tetrasulphide (DPTT) and tetramethylthiuram disulphide (TMTD).

It is also possible to use further additions which can help to increase the crosslinking yield in the sulphur vulcanization of the inventive nitrite rubbers. In principle, the crosslinking can also be effected with sulphur or sulphur donors alone.

Conversely, crosslinking of the inventive nitrile rubber can also be effected only in the presence of the abovementioned additions, i.e. without addition of elemental sulphur or sulphur donors.

Suitable additions which can help to increase the crosslinking yield are, for example, dithiocarbamates, thiurams, thiazoles, sulphenamides, xanthogenates, guanidine derivatives, caprolactams and thiourea derivatives.

Dithiocarbamates used may be, for example: ammonium dimethyldithiocarbamate, sodium diethyldithiocarbamate (SDEC), sodium dibutyldithiocarbamate (SDBC), zinc dimethyldithiocarbamate (ZDMC), zinc diethydithiocarbamate (ZDEC), zinc dibutyldithiocarbamate (ZDBC), zinc ethylphenyldithiocarbamate (ZEPC), zinc dibenzyldithiocarbamate (ZBEC), zinc pentamethylenedithiocarbamate (Z5MC), tellurium diethyldithiocarbamate, nickel dibutyldithiocarbamate, nickel dimethyldithiocarbamate and zinc diisononyldithiocarbamate.

Thiurams used may be, for example, tetramethythiurami disulphide (TMTD), tetramethylthiuram monosulphide (TMTM), dimethyldiphenylthiuram disulphide, tetrabenzylthiuram disulphide, dipentamethylenethiuram tetrasulphide car tetraethylthiuram disulphide (TETD).

Thiazoles used may be, for example, 2-mercaptobenzothiazole (MBT), dibenzothiazyl disulphide (MBTS), zinc mercaptoberizothiazole (ZMBT) or copper 2-mercaptobenzothiazole.

Sulphenamide derivatives used may be, for example, N-cyclohexyl-2-benzothiazylsulphenamide (CBS), N-tert-butyl-2-benzothiazylsulphenamide (TBBS), N,N′-dicyclohexyl-2-benzothiazylsulphenamide (DCBS), 2-morpholinothiobenzothiazole (MBS), N-oxydiethylenethiocarbamyl-N-tert-butylsulphenamide or oxydiethylenethiocarbamyl-N-oxyethylenesulphenamide.

Xanthogenates used may be, for example, sodium dibutylxanthogenate, zinc isopropyldibutylxanthogenate or zinc dibutylxanthonnate.

Guanidine derivatives used may be, for example, diphenylguanidine (DPG), di-o-tolylguanidine (DOTG) or o-tolyibiguanide (OTBG).

Dithiophosphates used may be, for example, zinc di(C₂-C₁₆)alkyldithiophosphates, copper di(C₂-C₁₆)alkyldithiophosphates and dithiophosphoryl polysulphide.

A caprolactam used may be, for example, dithiobiscaprolactam.

Thiourea derivatives used may be, for example, N,N′-diphenylthiourea (DPTU), diethylthiourea (DETU) and ethylenethiourea (ETU).

Equally suitable as additions are, for example, zinc diaminodiisocyanate, hexamethylenetetramine, 1,3-bis(citraconimidomethyl)benzene and cyclic disulphanes.

The additions and crosslinking agents mentioned can be used either individually or in mixtures. Preference is given to using the following substances for the crosslinking of the nitrile rubbers: sulphur, 2-mercaptobenzothiazole, tetramethylthiuram disulphide, tetramethylthiuram monosulphide, zinc dibenzyldithiocarbamate, dipentamethylenethiuram tetrasulphide, zinc dialkyldithiophosphate, dimorpholyl disulphide, tellurium diethyldithiocarbamate, nickel dibutyldithiocarbamate, zinc dibutyldithiocarbamate, zinc dimethyldithiocarbamate and dithiobiscaprolactam.

The crosslinking agents and aforementioned additions can each be used in amounts of about 0.05 to 10 phr, preferably 0.1 to 8 phr, especially 0.5 to 5 phr (single dose, based in each case on the active substance).

In the case of sulphur crosslinking, it is possible, in addition to the crosslinking agents and abovementioned additions, also to use further inorganic or organic substances as well, such as zinc oxide, zinc carbonate, lead oxide, magnesium oxide, saturated or unsaturated organic fatty acids and zinc salts thereof, polyalcohols, amino alcohols, for example triethanolamine, and amines, for example dibutylamine, dicyclohexylamine, cyclohexylethylamine and polyether amines.

If the inventive hydrogenated nitrile rubbers are those including repeating units of one or more termonomers containing carboxyl groups, crosslinking can also be effected via the use of a polyamine crosslinker, preferably in the presence of a crosslinking accelerator. The polyamine crosslinker is not restricted, provided that it is either (1) a compound that contains two or more amino groups (optionally also in salt form) or (2) a species that forms a compound that forms two or more amino groups in situ during the crosslinking reaction. Preference is given to using an aliphatic or aromatic hydrocarbon compound in which at least two hydrogen atoms are replaced either by amino groups or else by hydrazide structures (the latter being a “—C(═O)NHNH₂” structure).

Examples of such polyamine crosslinkers (ii) are:
aliphatic polyamines, preferably hexamethylenediamine, hexamethylenediamine carbamate, tetramethylenepentamine, hexamethylenediamine-cinnamaldehyde adduct or hexamethylenediamine dibenzoate;
aromatic polyamines, preferably 2,2-bis(4-(4-aminophenoxy)phenyl)propane, 4,4′-methylenedianiline, m-phenylenediamine, p-phenylenediamine 4,4′-methylenebis(o-chloroaniline);
compounds having at least two hydrazide structures, preferably isophthalic dihydrazide, adipic dihydrazide or sebacic dihydrazide.

Particular preference is given to hexamethylenediamine and hexamethylenediamine carbamate.

The amount of the polyamine crosslinker in the vulcanizable mixture is typically in the range from 0.2 to 20 parts by weight, preferably in the range from 1 to 15 parts by weight and more preferably in the range from 1.5 to 10 parts by weight, based on 100 parts by weight of the hydrogenated nitrile rubber.

Crosslinking accelerators used in combination with the polyamine crosslinker may be any known to those skilled in the art, preferably a basic crosslinking accelerator. Usable examples include tetramethylguanidine, tetraethylguanidine, diphenylguanidine, di-o-tolylguanadine (DOTG), o-tolylbiguanidine and di-o-tolylguanadine salt of dicatecholboric acid. Additionally usable are aldehyde amine crosslinking accelerators, for example n-butylaldehydeaniline. More preferably at least one bi- or polycyclic aminic base is used as crosslinking accelerator. These are known to those skilled in the art. The following are especially suitable: 1,8-diazabicyclo[5.4.0]undec-7-ene (DBU), 1,5-diazabicyclo[4.3.0]-5-nonene (DBN), 1,4-diazabicyclo[2,2,2]octane (DABCO), 1,5,7-triazabicyclo[4.4.0]dec-5-ene (TBD), 7-methyl-1,5,7-triazabicyclo[4.4.0]dec-5-ene (MTBD).

The amount of the crosslinking accelerator in this case is typically within a range from 0.5 to 10 parts by weight, preferably 1 to 7.5 parts by weight, especially 2 to 5 parts by weight, based on 100 parts by weight of the hydrogenated nitrile rubber.

The vulcanizable mixture based on the inventive hydrogenated nitrile rubber may in principle also contain scorch retardants, which differ between vulcanization with sulphur and with peroxides:

In the case of vulcanization with sulphur, the following are used: cyclohexylthiophthalimide (CTP), N,N′-dinitrosopentamethylenetetramine (DNPT), phthalic anhydride (PTA) and diphenylnitrosamine. Preference is given to cyclohexylthiophthalimide (CTP).

In the case of vulcanization with peroxides, scorch is retarded using compounds as specified in WO-A-97101597 and U.S. Pat. No. 4,857,571. Preference is given to sterically hindered p-dialkylaminophenols, especially Ethanox 703 (Sartomer).

These further customary rubber additives include, for example, the typical substances known to those skilled in the art, such as fillers, filler activators, antiozonants, aging stabilizers, antioxidants, processing aids, extender oils, plasticizers, reinforcing materials and mould release agents.

Fillers used may, for example, be carbon black, silica, barium sulphate, titanium dioxide, zinc oxide, calcium oxide, calcium carbonate, magnesium oxide, aluminium oxide, iron oxide, aluminium hydroxide, magnesium hydroxide, aluminium silicates, diatomaceous earth, talc, kaolins, bentonites, carbon nanotubes, Teflon (the latter preferably in powder form), or silicates. The fillers are typically used in amounts in the range from 5 to 350 parts by weight, preferably from 5 to 300 parts by weight, based on 100 parts by weight of the hydrogenated nitrile rubber.

Useful filler activators include organic silanes in particular, for example bis(triethoxysilylpropyl tetrasulphide), bis(triethoxysilylpropyl disulphide), vinyltrimethyloxysilane, vinyldimethoxymethylsilane, vinyltriethoxysilane, vinyltris(2-methoxyethoxy)silane, N-cyclohexyl-3-aminopropyltrimethoxysilane, 3-aminopropyltrimethoxysilane, methyltrimethoxysilane, methyltriethoxysilane, dimethyldimethoxysilane, dimethyldiethoxysilane, trimethylethoxysilane, isooctyltrimethoxysilane, isooctyltriethoxysilane, hexadecyltrimethoxysilane or (octadecyl)methyldimethoxysilane. Further filler activators are, for example, interface-active substances such as triethanolamine and ethylene glycols with molecular weights of 74 to 10 000 g/mol. The amount of filler activators is typically 0 to 10 phr, based on 100 phr of the nitrile rubber.

Examples of useful mould release agents include saturated or partly unsaturated fatty acids and oleic acids and derivatives thereof (fatty acid esters, fatty acid salts, fatty alcohols, fatty acid amides), which are preferably used as a mixture constituent, and also products applicable to the mould surface, for example products based on low molecular weight silicone compounds, products based on fluoropolymers and products based on phenol resins.

The mould release agents are used as a mixture constituent in amounts of about 0 to 10 phr, preferably 0.5 to 5 phr, based on 100 phr of the nitrile rubber.

Another possibility is reinforcement with strengthening agents (fibres) made of glass, according to the teaching of U.S. Pat. No. 4,826,721, and another is reinforcement by cords, woven fabrics, fibres made of aliphatic and aromatic polyamides (Nylon®, Aramid®), polyesters and natural fibre products.

The mixing of the components for the purpose of producing the vulcanizable mixtures is typically effected either in an internal mixer or on a roll. Internal mixers used are typically those having what is called an intermeshing rotor geometry. At the starting point, the internal mixer is charged with the inventive nitrile rubber. This is typically in bale form and in that case is first comminuted. After a suitable period, which can be fixed by the person skilled in the art without difficulty, the additives are added, and typically, at the end, the crosslinking system. The mixing is effected under temperature control, with the proviso that the mixture remains at a temperature in the range from 100 to 150° C. for a suitable time. After a suitable mixing period, the internal mixer is vented and the shaft is cleaned. After a further period, the internal mixer is emptied to obtain the vulcanizable mixture. All the aforementioned periods are typically in the region of a few minutes and can be fixed by the person skilled in the art without difficulty as a function of the mixture to be produced. If rollers are used as mixing units, it is possible to proceed in an analogous manner and sequence in the metered addition.

The invention further provides a process for producing vulcanizates based on the inventive nitrile rubbers, characterized in that the vulcanizable mixtures comprising the inventive nitrile rubber are subjected to vulcanization. Typically, the vulcanization is effected at temperatures in the range from 100° C. to 200° C., preferably at temperatures of 20° C. to 190° C. and especially preferably of 130° C. to 180° C.

The vulcanization is preferably effected in a shaping process.

For this purpose, the vulcanizable mixture is processed further by means of extruders, injection moulding systems, rolls or calenders. The preformed mass thus obtainable is typically then vulcanized to completion in presses, autoclaves, hot air systems, or in what are called automatic mat vulcanization systems, and useful temperatures have been found to be in the range from 120° C. to 200° C., preferably 140° C. to 190° C. The vulcanization time is typically 1 minute to 24 hours and preferably 2 minutes to 1 hour. Depending on the shape and size of the vulcanizates, a second vulcanization by reheating may be necessary to achieve complete vulcanization.

The invention accordingly provides the vulcanizates thus obtainable, based on the inventive nitrile rubbers, preferably in the form of mouldings These vulcanizates may take the form of a drive belt, of roller coverings, of a seal, of a cap, of a stopper, of a hose, of floor covering, of sealing mats or sheets, profiles or membranes. Specifically, the vulcanizates may be an O-ring seal, as flat seal, a shaft sealing ring, a gasket sleeve, a sealing cap, a dust protection cap, a connector seal, a thermal insulation hose (with or without added PVC), an oil cooler hose, an air suction hose, a power steering hose, a shoe sole or parts thereof, or a pump membrane.

### EXAMPLES

I Characterization Methods

The quantitative determination of 2,6-di-tert-butyl-p-cresol (Vulkanox® KB) in the nitrile rubber or in the hydrogenated nitrile rubber is effected by gas chromatography using an internal standard (naphthalene). For the determination, 3 to 5 g of polymer with an accuracy of 0.01 g are dissolved in 40 ml of a toluene/THF mixture (volume ratio 1:1) with stirring in a sealable Erlenmeyer flask. 20 mg of naphthalene (dissolved in 5 ml of toluene) are added to the solution as an internal standard and distributed homogeneously by stirring. The polymer is precipitated by adding 80 ml of methanol. The serum is analysed by gas chromatography (Agilent Technologies, instrument: 6890, Waldbronn, Germany) with the following instrument settings:
Capillary column: HP-5, length: 30 m; internal diameter 0.32 mm; film thickness: 0.25 μm
Injection volume: 1 μl
Injection temperature: 320° C.
Oven temperature programme: 100° C., heating rate: 10° C./min>300° C.
Detector temperature: 300° C.

Under these conditions, a retention time of 3.4 min is found for 2,6-di-tert-butyl-p-cresol, and a retention time of 6.44 min for naphthalene.

In independent measurements, with the same instrument settings, the response ratio of 2,6-di-tert-butyl-p-cresol relative to naphthalene is determined as the basis for the calculation of the content of 2,6-di-tert-butyl-p-cresol.

The recovery rate (“RR”) of 2,6-di-tert-butyl-p-cresol in the dried nitrile rubber (KB _{BR}) is calculated on the basis of the amount of 2,6-di-tert-butyl-p-cresol (KB ₗₐₜₑₓ) present in the latex by the following formula:

$$RR = \frac{100 \times {KB}_{NBR}}{{KB}_{Latex}}$$

in which

| | |
|---|---|
| “RR” | recovery rate in % |
| KB_{NBR} | Vulkanox KB content in the dry nitrile rubber determined in % |
| | by weight |
| KBₗₐₜₑₓ | amount of Vulkanox KB added to the NBR latex in % by |
| | weight based on dry nitrile rubber |

The volatile fractions were determined in accordance with ISO 248:2005 (E) (fourth edition of 15.06.2005),, Rubber, raw—Determination of volatile matter content” by the “Oven Method” described in point 3.2.

For determination of the gel content, 250 mg of the nitrile rubber were dissolved in 25 ml of methyl ethyl ketone at 25° C. while stirring for 24 h. The insoluble fraction was removed by ultracentrifugation at 20 000 rpm at 25° C., dried and determined gravimetrically. The gel content is reported in % by weight based on the starting weight and has values of <1.0% by weight.

For the determination of the calcium content, 0.5 g of the nitrile rubbers were digested by dry ashing at 550° C. in a platinum crucible with subsequent dissolution of the ash in hydrochloric acid. After suitable dilution of the digestion solution with deionized water, the calcium content was determined by ICP-OES (inductively coupled plasma-optical emission spectroscopy) at a wavelength of 317.933 nm against calibration solutions adjusted with an acid matrix. According to the concentration of the elements in the digestion solution and/or sensitivity of the measuring instrument used, the concentrations of the sample solutions for each of the wavelengths used were fitted to the linear range of the calibration (B. Welz “Atomic Absorption Spectrometry”, 2nd Ed., Verlag Chemie, Weinheim 1985)

The chlorine content of the inventive nitrile rubbers is determined based on DIN EN 14582, Method A, as follows: The nitrile rubber sample is digested in a Parr pressure vessel in a melt of sodium peroxide and potassium nitrate. Sulphite solution is added to the resultant melt, which is acidified with sulphuric acid. In the solution obtained, the chloride formed is determined by a potentiometric titration with silver nitrate solution and calculated as chlorine.

The Mooney viscosities of the unvulcanized nitrile rubbers or of the unvulcanized hydrogenated nitrile rubbers were determined in a shearing disc viscometer to DIN 53523/3 or ASTM D 1646 at 100° C. The Mooney viscosities of the dried, unaged nitrile rubbers or of the unaged hydrogenated nitrile rubbers are referred to hereinafter as MV 0.

To determine the storage stability, the unvulcanized nitrile rubber was subjected to hot air storage (48 h) in an air circulation drying cabinet at 100° C. The Mooney viscosity values determined after storage at 100° C. for 48 hours were referred to as MV 1. The storage stability (SS) was determined as the difference between the Mooney viscosity values after hot air storage (MV 1) and before hot air storage (MV 0).

SS(48 h/100° C.)=MV 1−MV 0

The storage stability of nitrile rubber (SS) is adequate provided that the Mooney viscosity changes by not more than 5 Mooney units in the course of storage at 100° C. for 48 hours (MV 1−MV 0).

II Scorch Behaviour and Vulcanization Rate

The vulcanization behaviour (“Mooney scorch”) is determined with the aid of a shearing disc viscometer to DIN 53 523 at 120° C. For the determination, a small rotor (S) is used. “MS 5 (120° C.)” means the time in minutes in which the Mooney viscosity value rises by 5 Mooney units compared to the minimum value.

The vulcanization rate is determined to DIN 53 529, Part 3, at 160° C. with the aid of a rheometer from Monsanto (MDR 2000E) as the difference t₉₀-t₁₀, where t₁₀ and t₉₀ are the vulcanization times at which, respectively, 10% and 90% of the final vulcanization level has been attained.

The vulcanization behaviour of the mixtures was determined in a rheometer at 160° C. to DIN 53 529. In this way, the characteristic vulcanization times t₁₀ and t₉₀ were determined.

III Mechanical Properties

The mechanical properties of the rubbers, such as stress value at 300% elongation (σ₃₀₀), ultimate tensile strength (σₘₐₓ) and elongation at break (ε_{b}), of vulcanizates are determined to DIN 53 504.

### EXAMPLES

A tabular overview of the examples conducted is given in Table 1. For the production of the nitrile rubbers, tert-dodecyl mercaptan from the manufacturers Lanxess (latex A) and Chevron Phillips (latex B) were used for molecular weight regulation. Prior to the latex coagulation, the latices were admixed with different amounts of 2,6-di-tert-butyl-p-cresol (Vulkanox® KB from Lanxess Deutschland GmbH). For the latex coagulation, sodium chloride or magnesium chloride was used. After latex coagulation and washing of the rubber crumbs obtained, these were subjected to preliminary dewatering by drip-drying on a sieve and mechanical squeezing, followed by thermal drying. The thermal drying was effected either in a vacuum drying cabinet (abbreviated to “VDC” in Table 1) or by fluidized bed drying (abbreviated to “FB” in Table 1).

TABLE 1
Overview of the experiments conducted (inventive products indicated by “*”)

| Latex | | | | | | | |
|---|---|---|---|---|---|---|---|
| | Molecular weight | | | | | | Vulkanox ® KB |
| | regulator | | Vulkanox ® KB | | | | Addition to rubber |
| | Lanxess | Phillips | Addition to latex | Precip. | NBR drying | | mixture |
| Example | TDM | TDM | [parts by wt.] | salt | VDC | FB | [parts by wt.] |
| 1.1 | A | — | 0.9 | NaCl | — | — | — |
| 1.2 | A | — | 1.20 | NaCl | — | — | — |
| 1.3 | A | — | 1.50 | NaCl | — | — | — |
| 1.4 | — | B | 1.20 | MgCl₂ | — | — | — |
| 1.5 | — | B | 1.60 | MgCl₂ | | — | — |
| 2.1 | A | — | 0.9 | NaCl | X | — | — |
| 2.2 | A | — | 1.20 | NaCl | X | — | — |
| 2.3 | A | — | 1.50 | NaCl | X | — | — |
| 2.4 | — | B | 1.20 | MgCl₂ | X | — | — |
| 2.5 | — | B | 1.60 | MgCl₂ | X | — | — |
| 3.1* | A | — | 0.9 | NaCl | — | X | — |
| 3.2* | A | — | 1.20 | NaCl | — | X | — |
| 3.3* | A | — | 1.50 | NaCl | — | X | — |
| 3.4* | — | B | 1.20 | MgCl₂ | — | X | — |
| 3.5* | — | B | 1.60 | MgCl₂ | — | X | — |
| 4.1 | A | — | 0.9 | NaCl | — | X | 0.5 |
| 5.1 | A | — | 0.9 | NaCl | — | X | 1.0 |

A Production of the NBR Latices by Emulsion Polymerization

On the basis of the formulations specified in Table 2 below, two NBR latices (latex A and latex B) were produced, which differ by the type of tertiary dodecyl mercaptan used for molecular weight regulation (Lanxess and Chevron Phillips). All the feedstocks are specified in parts by weight based on 100 parts by weight of the monomer mixture.

TABLE 2
Feedstocks for the production of the NBR latices A and B

| Feedstocks | | |
|---|---|---|
| [parts by weight] | Latex A | Latex B |
| butadiene | 73 | 73 |
| acrylonitrile | 27 | 27 |
| Total amount of water | 174 + 16 + 30 | 174 + 16 + 30 |
| Erkantol ® BXG¹⁾ | 3.67 | 3.67 |
| Baykanol ® PQ²⁾ | 1.10 | 1.10 |
| K salt of coconut fatty acid | 0.73 | 0.73 |
| KOH | 0.05 | 0.05 |
| t-DDM³⁾ | 0.24 + 0.24 | — |
| t-DDM³⁾ | — | 0.31 + 0.31 |
| potassium | 0.39 + 0.19 | 0.39 + 0.19 |
| peroxodisulphate⁵⁾ | | |
| tris(α-hydroxyethyl)amine⁶⁾ | 0.55 | 0.55 |
| Na dithionite⁷⁾ | 1.19 | 1.19 |
| potassium hydroxide | 1.28 | 1.28 |

¹⁾Na salt of a mixture of mono- and disulphonated naphthalenesulphonic acids with isobutylene oligomer substituents (Erkantol ® BXG)
²⁾Na salt of methylene bis(naphthalenesulphonate) (Baykanol ® PQ, Lanxess Deutschland GmbH)
³⁾t-DDM (tertiary dodecyl mercaptan): C₁₂ mercaptan mixture from Lanxess Deutschland GmbH
³⁾t-DDM (tertiary dodecyl mercaptan); C₁₂ mercaptan mixture from Chevron Phillips Chemical Company LP (Sulfole ® 120)
⁵⁾potassium peroxodisulphate (Aldrich cat. no.: 21,622-4)
⁶⁾tris(α-hydroxyethyl)amine (Aldrich cat. no.: T5,830-0)
⁷⁾Na dithionite (Aldrich cat. no.: 15,795-3)

The NBR latex was produced batchwise in a 2 m³ stirred autoclave.

In the batch, 350 kg of the monomer mixture and a total amount of water of 770 kg were used. The autoclave was initially charged with the emulsifiers Erkantol® BXG (12.85 kg), Baykanol® PQ (3.85 kg) and the potassium salt of coconut fatty acid (2.56 kg) in 609 kg of this amount of water together with 84 g of sodium hydroxide, and purged with a nitrogen stream. Thereafter, the destabilized monomers (255.5 kg of butadiene and 94.5 kg of acrylonitrile) and a portion of the regulator were added to the reactor. In the case of latex A 0.84 kg of tert-dodecyl mercaptan from Lanxess, and in the case of latex B 1.09 kg of tert-dodecyl mercaptan from Chevron Phillips were added. The remaining amount of water (161 kg) was used for the production of the aqueous solutions of tris(α-hydroxyethyl)amine, potassium peroxodisulphate and sodium dithionite.

By addition of aqueous solutions of 1.365 kg of potassium peroxodisulphate (corresponding to the 0.39 part by weight according to Table 1) and 1.925 kg of tris(α-hydroxyethyl)amine (corresponding to the 0.55 part by weight according to Table 1), the polymerization was started at 17° C. and kept at this temperature over the entire duration. The course of the polymerization was monitored by gravimetric determinations of conversion. At a polymerization conversion of 15% in the case of latex A a further 0.84 kg of tert-dodecyl mercaptan from Lanxess (corresponding to 0.24 part by weight according to Table 2) was metered in, or in the case of latex B a further 1.09 kg of tert-dodecyl mercaptan from Chevron Phillips (corresponding to 0.31 part by weight according to Table 2) and 0.665 kg of potassium peroxodisulphate (corresponding to 0.19 part by weight according to Table 1). On attainment of 70% conversion, the polymerization batches were stopped by addition of 4.165 kg of sodium dithionite (1.19 parts by weight) and 4.48 kg of potassium hydroxide (1.28 parts by weight) dissolved in 105 kg of water (30 parts by weight). Unconverted monomers and other volatile constituents were removed by means of steam distillation under reduced pressure.

The characteristic data for the latices A and B obtained are summarized in Table 3 below.

TABLE 3
Characteristic data for the NBR latices A and B

| Latex | A | B |
|---|---|---|
| Solids content [% by wt.] | 21.5 | 22.1 |
| pH | 8.9 | 8.7 |
| Acrylonitrile content [% by wt.] | 28.9 | 28.4 |

B Workup of the NBR Latices A and B

Prior to the coagulation, the NBR latices A and B were admixed with different amounts of 4-methyl-2,6-tert-butylphenol (Vulkanox® KB der Lanxess Deutschland GmbH) (Table 4). For this purpose, a 50% dispersion of Vulkanox® KB in water was used.

The aqueous dispersion of Vulkanox® KB was based on the following formulation, prepared at 95 to 98° C. with the aid of an Ultraturrax:

| | |
|---|---|
| 360 g | deionized water (DW water) |
| 40 g | alkylphenol polyglycol ether (NP ® 10 emulsifier |
| | from Lanxess Deutschland GmbH) |
| 400 g | Vulkanox ® KB or Vulkanox ® BKF from |
| | Lanxess Deutschland GmbH |

The additions of 4-methyl-2,6-tert-butylphenol were based on the nitrile rubber solids present in the latex and are reported in % by weight (Table 4).

For the coagulation of the NBR latices, aqueous solutions of sodium chloride or magnesium chloride were used. The concentrations of the salt solutions and the amounts of salts used for the precipitation were each calculated without water of crystallization and were based on the solids present in the latex.

Both the sodium chloride solution and the magnesium chloride solution were 26% by weight solutions, using normal service water (not deionized and hence containing calcium ions) for the production of the aqueous solution.

The aging stabilizers used for the stabilization of the nitrile rubbers, and the amounts thereof, the salts used for latex coagulation, the concentration of the salt solutions, the amounts of salts used based on the nitrile rubber, the coagulation temperature, the washing temperature and the duration of the washing are summarized in Table 4.

TABLE 4
Additions of Vulkanox ® KB and workup of the NBR latices A and B

| | | | | | Concentration | Amount of | | | | |
|---|---|---|---|---|---|---|---|---|---|---|
| | | Vulkanox ® | | | of the salt | salt based | Coagulation | Wash conditions | | |
| | | | Amount | Precip. | solution | on NBR | temperature | Type of | T | Time |
| Example | Latex | Type | [% by wt.] | salt | [% by wt.] | [% by wt.] | [° C.] | water | [° C.] | [h] |
| 1.1 | A | KB | 0.9 | NaCl | 26 | 53.3 | 60 | SW | 23 | 5 |
| 1.2 | A | KB | 1.20 | NaCl | 26 | 53.3 | 60 | SW | 23 | 8 |
| 1.3 | A | KB | 1.50 | NaCl | 26 | 53.3 | 60 | SW | 23 | 8 |
| 1.4 | B | KB | 1.20 | MgCl₂ | 26 | 2.37 | 60 | SW | 60 | 8 |
| 1.5 | B | KB | 1.60 | MgCl₂ | 26 | 2.37 | 60 | SW | 60 | 5 |

The workup of the NBR latices was effected batchwise in a stirrable, open vessel of capacity 200 l, equipped with an inlet and outlet. The outlet could be shut off by means of a screen (mesh size 2 mm) via two lateral rails, such that the rubber crumbs obtained in the latex coagulation were not washed out in the washing operation.

For the coagulation, an amount of latex that was calculated such that 25 kg of solids were obtained in each case at 100% yield was used. The latex was initially charged in the coagulation vessel, heated to 60° C. and coagulated by gradual addition of aqueous salt solution while stirring. On completion of the latex coagulation, the rubber crumbs were washed by dilution washing without prior removal of the serum. For the crumb washing, normal calcium ion-containing tap water (“SW”) was used, with constant throughput of wash water (200 l/h).

After the washing had ended, the rubber crumbs were removed with a sieve, freed of adhering water by drip-drying, and then squeezed mechanically to residual moisture contents of 12 to 25% by weight in a welding screw.

Subsequently, the products were dried in a vacuum drying cabinet (VDC) or by means of fluidized bed drying (FB).

The drying in a vacuum drying cabinet was effected batchwise and 70° C., while passing a gentle air stream through during the drying. After the drying, the contents of volatile components were <1.0% by weight.

The fluidized bed drying was conducted batchwise in a laboratory dryer (TG 200 high-speed dryer) from Kurt Retsch (Haan/Dusseldorf). For the FB drying, 1.2 kg in each case of the mechanically dewatered rubber were used. The flow rate of the hot air was kept constant at 100 m³/h in all the experiments. The temperature and the residence times in the fluidized bed drying were varied (Table 6a).

After the thermal drying, the unvulcanized nitrile rubbers were characterized analytically (contents of 4-methyl-2,6-tert-butylphenol, calcium, chlorine and gel), and in terms of their storage stability (SS).

Table 5 summarizes the properties of the nitrile rubbers obtained by drying in a vacuum drying cabinet.

TABLE 5
Properties of the unvulcanized nitrile rubbers 2.1-2.5 dried in a vacuum drying cabinet (noninventive)

| | | | | | Ageing stabilizer | | | | | | | |
|---|---|---|---|---|---|---|---|---|---|---|---|---|
| | | Addition of | | | in NBR | | | | | | | |
| | | Vulkanox ® | | | | Recovery | Contents | | | ML1 + 4@100° C. | | |
| | | | Amount | Precip. | Content | rate | Ca | Chlorine | Gel | MV0 | MV1 | SS |
| NBR | Latex | Type | [% by wt.] | salt | [% by wt.] | [%] | [ppm] | [ppm] | [%] | [MU] | [MU] | [MU] |
| 2.1 | A | KB | 0.9 | NaCl | 0.9 | 100 | 650 | 120 | 0.4 | 47 | 48 | 1 |
| 2.2 | A | KB | 1.20 | NaCl | 1.16 | 97 | 600 | 120 | 0.6 | 46 | 48 | 2 |
| 2.3 | A | KB | 1.50 | NaCl | 1.48 | 99 | 490 | 130 | 0.4 | 44 | 45 | 1 |
| 2.4 | B | KB | 1.20 | MgCl₂ | 1.20 | 100 | 330 | 87 | 0.5 | 46 | 48 | 2 |
| 2.5 | B | KB | 1.60 | MgCl₂ | 1.58 | 99 | 390 | 75 | 0.7 | 45 | 47 | 2 |

After VDC drying, the contents of 4-methyl-2,6-tert-butylphenol are in the range of 0.9 to 1.58% by weight (Table 5). This is used to calculate, on the basis of the amounts of Vulkanox® KB added to the latex, recovery rates for 4-methyl-2,6-tert-butylphenol of 97 to 100%. The recovery rates are independent of the type of electrolyte used in the latex coagulation and the conditions employed in the crumb washing. In addition, the nitrile rubber dried thermally in the VDC has an adequate storage stability SS. The Ca contents are in the range of 390 to 650 ppm, the chlorine contents in the range of 75 to 130 ppm and the gel contents in the range of 0.4 to 0.7% by weight.

Table 6a summarizes the conditions for the fluidized bed drying of the nitrile rubbers.

TABLE 6a
Conditions in the fluidized bed drying of the nitrile
rubbers (inventive products indicated by “*”)

| | | | | Conditions in the | | |
|---|---|---|---|---|---|---|
| | | Addition of | | fluidized bed drying | | |
| | | Vulkanox ® | | Residual | Temper- | |
| | | | Amount | moisture | ature | Time |
| NBR | Latex | Type | [% by wt.] | [% by wt.] | [° C.] | [min] |
| 3.1* | A | KB | 0.9 | 15 | 110 | 8 |
| 3.2* | A | KB | 1.20 | 17 | 120 | 6 |
| 3.3* | A | KB | 1.50 | 25 | 135 | 5 |
| 3.4* | B | KB | 1.20 | 12 | 125 | 5 |
| 3.5* | B | KB | 1.60 | 16 | 125 | 5 |

Table 6b summarizes the properties of the nitrile rubbers obtained after fluidized bed drying.

TABLE 6b
Properties of the nitrile rubbers dried in a fluidized
bed (inventive products indicated by “*”)

| | | Vulkanox ® KB | | | | | | |
|---|---|---|---|---|---|---|---|---|
| | | | Amount in | Recovery | Gel | ML1 + 4@100° C. | | |
| | | Addition | the NBR | rate | content | MV 0 | MV 1 | SS |
| NBR | Latex | [% by wt.] | [% by wt.] | [%] | [% by wt.] | [MU] | [MU] | [MU] |
| 3.1* | A | 0.9 | 0.49 | 54 | 0.5 | 43 | 45 | 2 |
| 3.2* | A | 1.20 | 0.59 | 49 | 0.5 | 44 | 46 | 2 |
| 3.3* | A | 1.50 | 0.81 | 54 | 0.4 | 46 | 49 | 3 |
| 3.4* | B | 1.20 | 0.61 | 51 | 0.6 | 44 | 45 | 1 |
| 3.5* | B | 1.60 | 0.79 | 49 | 0.5 | 45 | 46 | 2 |

After FB drying, the contents of 4-methyl-2,6-tert-butylphenol are in the range of 0.49 to 0.81% by weight (Table 6b). This is used to calculate, on the basis of the amounts of Vulkanox® KB added to the latex, recovery rates for 4-methyl-2,6-tert-butylphenol of 49 to 54%. The recovery rates are independent of the type of electrolyte used in the latex coagulation and the conditions employed in the crumb washing. In addition, the nitrile rubber obtained by FB drying has gel contents in the range from 0.4 to 0.6% by weight, and an adequate storage stability SS.

For the determination of the vulcanization characteristics of the unvulcanized rubber mixtures and of the vulcanizates properties, rubber mixtures were produced on the basis of the nitrile rubbers obtained in the noninventive examples 2.1 to 2.5 and the inventive examples 3.1* to 3.5*. For this purpose, an internal mixer of capacity 1.51 (GK. 1,5 from Werner & Pfleiderer, Stuttgart) with intermeshing kneading elements (PS 5A-paddle geometry) was used.

The individual mixture constituents were added to the internal mixer in the sequence specified in Table 7. All the mixture constituents are based on 100 parts by weight of the nitrile rubber.

TABLE 7
Composition of the rubber mixtures

| | Amount in parts by |
|---|---|
| Mixture constituents | weight |
| NBR | 100.0 |
| stearic acid | 2.0 |
| zinc oxide | 5.0 |
| N330 carbon black | 40.0 |
| phenol/formaldehyde resin (Plastikator ® FH) | 5.0 |
| N-Cyclohexylbenzothiazylsulphenamide | 0.9 |
| (Vulkacit ® CZ, Lanxess Deutschland GmbH) | |
| sulphur | 1.5 |

The properties determined in these mixtures are summarized in Table 8.

TABLE 8
Properties of the nitrile rubbers from noninventive examples 2.1-2.5 and inventive examples 3.1*-3.5*

| | | | | | Vulcanization | | | | | | |
|---|---|---|---|---|---|---|---|---|---|---|---|
| | | | | Vulkanox ® KB | MS 5 | | | | Vulcanizate properties | | |
| | Salt | Drying | | content (NBR) | (120° C.) | t₁₀ | t₉₀ | t₉₀ − t₁₀ | σ₃₀₀ | σ_{max.} | ε_{b} |
| Example | type | VDC | FB | [% by wt.] | [min] | [sec] | [sec] | [sec] | [MPa] | [MPa] | [%] |
| 2.1 | NaCl | X | — | 0.9 | 48 | 7.3 | 13.3 | 6.0 | 8.4 | 22.7 | 578 |
| 2.2 | NaCl | X | — | 1.16 | 47 | 7.0 | 12.3 | 5.3 | 8.1 | 21.9 | 577 |
| 2.3 | NaCl | X | — | 1.48 | 45 | 6.9 | 12.8 | 5.9 | 8.2 | 22.1 | 598 |
| 2.4 | MgCl₂ | X | — | 1.20 | 45 | 7.2 | 13.5 | 6.3 | 8.2 | 22.6 | 591 |
| 2.5 | MgCl₂ | X | — | 1.58 | 44 | 6.8 | 13.3 | 6.5 | 8.1 | 22.2 | 589 |
| 3.1* | NaCl | — | X | 0.49 | 51 | 7.9 | 11.8 | 3.90 | 8.7 | 22.2 | 570 |
| 3.2* | NaCl | — | X | 0.59 | 49 | 7.6 | 11.4 | 3.8 | 8.9 | 22.8 | 570 |
| 3.3* | NaCl | — | X | 0.81 | 49 | 7.6 | 11.6 | 4.0 | 8.5 | 22.6 | 560 |
| 3.4* | MgCl₂ | — | X | 0.61 | 50 | 7.7 | 12.1 | 4.4 | 8.8 | 23.1 | 574 |
| 3.5* | MgCl₂ | — | X | 0.79 | 49 | 7.4 | 12.6 | 5.2 | 8.5 | 22.8 | 574 |

Table 8 shows that the inventive nitrile rubbers3.1*, 3.2*, 3.3*, 3.4* and 3.5* have higher scorch resistance (greater MS 5 values), slower onset of vulcanization (greater t10 values), a higher vulcanization rate (t₉₀-t₁₀) and, in the vulcanized state, higher stress values at 300% elongation (σ₃₀₀) and comparably good elongations at break. Through this comparison, the advantages of the nitrile rubbers produced in accordance with the invention are clearly apparent.

For direct evidence of the harmful influence of an excessively high amount of 4-methyl-2,6-tert-butylphenol, proceeding from the inventive nitrile rubber 3.1*, Vulkanox® KB was added in amounts of 0.5 part by weight (Example 4.1) and 1.0 part by weight (Example 5.1) in the course of mixture production. The basis mixture used for examples 4.1 and 5.1 was the rubber mixture specified in Table 7. The Mooney scorch (MS 5), the vulcanization characteristics (t₁₀, t₉₀ and t₉₀-t₁₀) and the vulcanizate properties (σ₃₀₀, σₘₐₓ and ε_{b}) of the rubber mixtures 4.1 and 5.1 were determined (Table 9).

TABLE 9
Influence of Vulkanox ® KB additions in mixture production

| | Vulkanox ® KB | | | | | | | | |
|---|---|---|---|---|---|---|---|---|---|
| | | Addition | | | | | | | |
| | in | in mixture | MS 5 | Vulcanization | | | Vulcanizate properties | | |
| | the NBR | production | (120° C.) | t₁₀ | t₉₀ | t₉₀ − t₁₀ | σ₃₀₀ | σ_{max.} | ε_{b} |
| Example | [% by wt.] | [phr] | [min] | [sec] | [sec] | [sec] | [MPa] | [MPa] | [%] |
| 3.1* | 0.49 | — | 51 | 7.9 | 11.8 | 3.90 | 8.7 | 22.2 | 570 |
| 4.1 | 0.49 | 0.5 | 48 | 7.2 | 12.8 | 5.8 | 8.2 | 22.1 | 592 |
| 5.1 | 0.4 | 1.0 | 45 | 6.7 | 13.5 | 6.8 | 7.8 | 22.5 | 575 |

*inventive examples indicated by “*”

As can be seen in Table 9, additions of 0.5 or 1.0 part by weight of Vulkanox® KB based on 100 parts by weight of nitrile rubber (phr) in the mixture production cause the scorch times (MS 5) and the vulcanization onset times (t₁₀) to become shorter (lower processing reliability), the vulcanization times (t₉₀t₁₀) to become longer and hence poorer, and the modulus values at 300% elongation (σ₃₀₀) to become lower and hence poorer.

1. A nitrile rubber comprising 0.25 to less than 0.9 wt % of at least one substituted phenol of the general formula (I) based on the nitrile rubber, 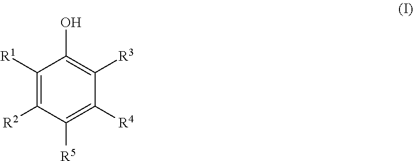
in which
R¹, R², R³, R⁴ and R⁵ are the same or different and are each hydrogen, hydroxyl, a linear, branched, cyclic or aromatic hydrocarbyl radical having 1 to 8 carbon atoms and additionally one, two or three heteroatoms, where at least one of the R¹, R², R³, R⁴ and R⁵ radicals is not hydrogen.

2. The nitrile rubber according to claim 1, wherein R¹, R², R³, R⁴ and R⁵ are the same or different and are each hydrogen, hydroxyl, a linear or branched C₁-C₈ alkyl radical, a linear or branched C₁-C₈ alkoxy radical, a C₃-C₈ cycloalkyl radical, or a phenyl radical, where at least one of the R¹, R², R³, R⁴ and R⁵ radicals is not hydrogen.

3. The nitrile rubber according to claim 2, wherein two or three of the R¹, R², R³, R⁴ and R⁵ radicals are hydrogen, and the other three or two of the R¹, R², R³, R⁴ and R⁵ radicals are the same or different and are each hydroxyl, a linear or branched C₁-C₈ alkyl radical, a linear or branched C₁-C₈ alkoxy radical, a C₃-C₈ cycloalkyl radical, or a phenyl radical.

4. The Nitrile rubber according to claim 1, wherein the at least one substituted phenol of the general formula (I) le selected from the group consisting of the following compounds:

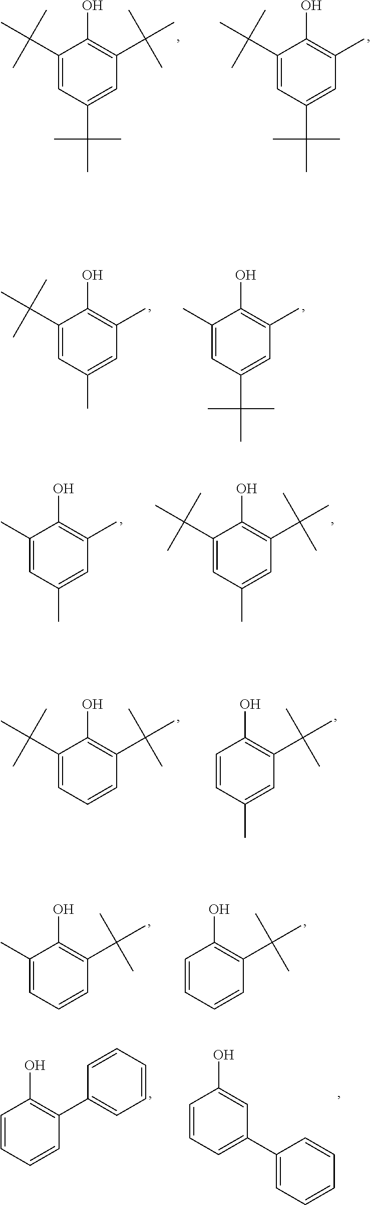

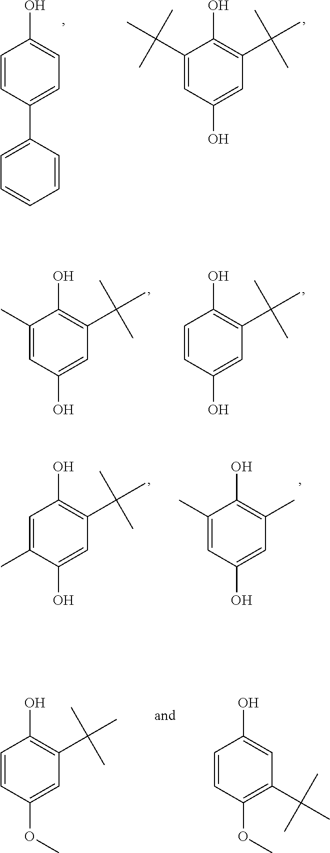

5. The nitrile rubber according to claim 1, wherein the nitrile rubber comprises repeating units derived from at least acrylonitrile and 1,3-butadiene.

6. The nitrile rubber according to claim 1, wherein the nitrile rubber has a storage stability SS less than 5 as defined by
SS(48 h/100° C.)=MV1−MV0
where
MV0 is the Mooney viscosity ML 1+4@ 100° C. determined to ASTM D 1646 of the nitrile rubber and
MV2 is the Mooney viscosity ML 1+4@ 100° C. determined to ASTM D 1646 of the same nitrile rubber after storage at 100° C. for 48 hours and.

7. A process for producing the nitrile rubbers according to claim 1, the process comprising:
(1) emulsion polymerization of at least one conjugated diene, at least one α,β-unsaturated nitrile and no further copolymerizable monomer or one or more further copolymerizable monomers, to produce a suspension of the nitrile rubber in an aqueous medium,
(2) admixing the suspension with at least one substituted phenol of the general formula (I), in an amount in the range of from 0.9 to 1.6% by weight, based on the nitrile rubber, 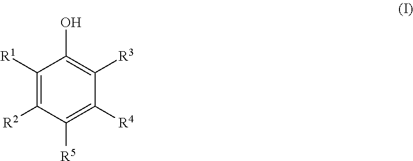
In which
R¹, R², R³, R⁴ and R⁵ are the same or different and are each hydrogen, hydroxyl, a linear, branched, cyclic or aromatic hydrocarbyl radical having 1 to 8 carbon atoms and additionally one, two or three heteroatoms, where at least one of the R¹, R², R³, R⁴ and R⁵ radicals is not hydrogen, and
(3) coagulating, isolating and drying the nitrile rubber,
wherein the drying is effected at a temperature of 100 to 180° C., and the content of substituted phenol is adjusted to 0.4% by weight to 0.85% by weight, based on the nitrile rubber.

8. Vulcanizable mixtures comprising at least one nitrile rubber according to claim 1 and at least one crosslinking system comprising at least one crosslinker and optionally one or more crosslinking accelerators.

9. A process for producing vulcanizates, the process comprising vulcanizing a vulcanizable mixture according to claim 8 in the course of a shaping process, at a temperature of 100° C. to 200° C.

10. Vulcanizates obtained by the process according to claim 9.

11. The nitrile rubber according to claim 1, wherein:
the nitrile rubber comprises 0.3 to 0.85% by weight of the at least one substituted phenol of the general formula (I), based in each case on the nitrile rubber,
R¹, R², R³, R⁴ and R⁵ are the same or different and are each hydrogen, hydroxyl, methyl, ethyl, propyl, n-butyl, t-butyl, methoxy, ethoxy, propoxy, cyclopentyl, cyclohexyl, or a phenyl radical, where at least one of the R¹, R², R³, R⁴ and R⁵ radicals is not hydrogen.

12. The nitrile rubber according to claim 11, wherein the nitrile rubber comprises 0.4% by weight to 0.85% by weight of the at least one substituted phenol of the general formula (I), based in each case on the nitrile rubber.

13. The nitrile rubber according to claim 12, wherein two or three of the R¹, R², R³, R⁴ and R⁵ radicals are hydrogen, and the other three or two of the R¹, R², R³, R⁴ and R⁵ radicals are the same or different and are each hydroxyl, methyl, ethyl, propyl, n-butyl, t-butyl, methoxy, ethoxy, propoxy, cyclopentyl, cyclohexyl, or a phenyl radical

14. The nitrile rubber according to claim 13, wherein the nitrile rubber comprises repeating units derived from only acrylonitrile and 1,3-butadiene.

15. The nitrile rubber according to claim 13, wherein the nitrile rubber comprises repeating units derived from acrylonitrile, 1,3-butadiene and one or more α,β-unsaturated mono- or dicarboxylic acid(s), or esters or amides thereof.

16. The nitrile rubber according to claim 13, wherein the nitrile rubber comprises:
repeating units derived from only acrylonitrile and 1,3-butadiene, or
repeating units derived from acrylonitrile, 1,3-butadiene, and one or more alkyl esters of an α,β-unsaturated carboxylic acid selected from the group of methyl (meth)acrylate, ethyl (meth)acrylate, propyl (meth)acrylate, n-butyl (meth)acrylate, t-butyl (meth)acrylate, hexyl (meth)acrylate, 2-ethylhexyl (meth)acrylate, octyl (meth)acrylate and lauryl (meth)acrylate.

17. The nitrile rubber according to claim 16, wherein the at least one substituted phenol of the general formula (I) is selected from the group consisting of the following compounds:

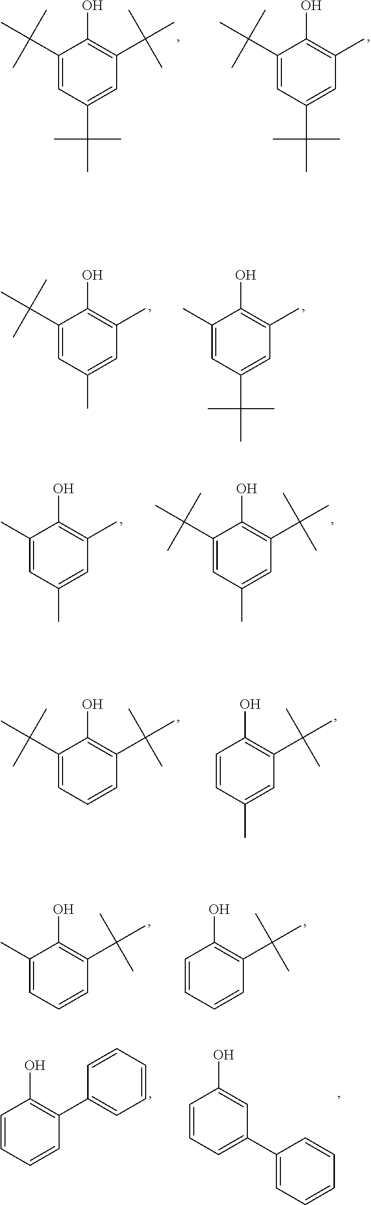

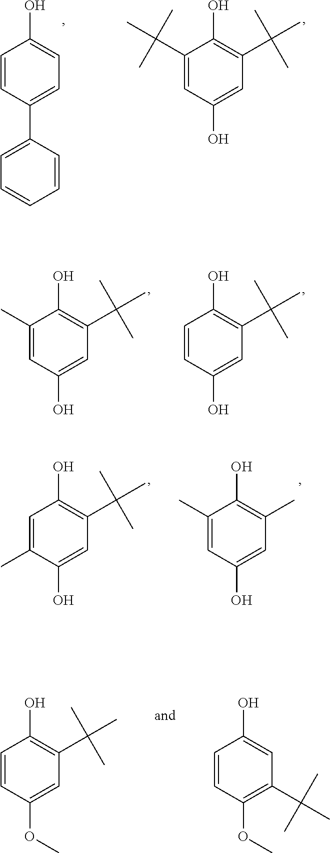

18. The nitrile rubber according to claim 17, the nitrile rubber has a storage stability SS of less than 5 as defined by
SS(48 h/100° C.)=MV1−MV0
where
MV0 is the Mooney viscosity ML 1+4@ 100° C. determined to ASTM D1646 of the nitrile rubber, and
MV2 is the Mooney viscosity ML 1+4@ 100° C. determined to ASTM D 1646 of the same nitrile rubber after storage at 100° C. for 48 hours.
